(19) United States
(12) Patent Application Publication
(10) Pub. No.: US 2025/0033976 A1
(43) Pub. Date: Jan. 30, 2025

(54) A GRAPHENE OXIDE AEROGEL

(71) Applicant: NewSouth Innovations Pty Limited, Sydney (AU)

(72) Inventors: Rakesh JOSHI, Sydney (AU); Xiao SUI, Sydney (AU); Tobias FOLLER, Sydney (AU); Dali JI, Sydney (AU); Xiaojun REN, Sydney (AU); Llewellyn OWENS, Moore Creek, New South Wales (AU)

(21) Appl. No.: 18/689,275

(22) PCT Filed: Sep. 6, 2022
(86) PCT No.: PCT/AU2022/051080

§ 371 Date: May 14, 2024

(30) Foreign Application Priority Data
Sep. 6, 2021 (AU) 2021902883

(51) Int. Cl. C01B 32/198; B01J 13/00; C01B 32/184

(52) U.S. Cl. CPC C01B 32/198; B01J 13/0091; C01B 32/184

(57) ABSTRACT

The present disclosure relates to an aerogel comprising graphene oxide which is crosslinked with a metal ion. The disclosure also relates to methods and apparatus for the use of graphene oxide aerogels, in particular as desiccants.

### CROSS REFERENCE

The present application claims priority to Australian provisional application number 2021902883, filed 6 Sep. 2021, the entire contents of which is incorporated herein by reference in its entirety.

### FIELD OF THE INVENTION

The invention relates to a graphene oxide aerogel, and to methods and apparatus for the use of such aerogels, in particular as desiccants. However, it will be appreciated that the invention is not limited to this particular field of use.

### BACKGROUND

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Nanoporous materials with large nano-sized pores and high surface area are of considerable interest worldwide for adsorption processes. Heterogeneous three dimensional porous materials such as silica gel and zeolites are widely used desiccant materials. However, issues such as large pore size distribution, low surface area to pore volume ratios, low hydrophilicity and/or poor hydrothermal stability associated with the aforementioned materials offer limitations for wide applicability.

Ideal desiccant materials for adsorption applications have a large surface area and high porosity with chemical and mechanical stability. Accordingly, there is a need to develop new desiccant materials having one or more of these desirable properties.

It is an object of the present invention to overcome or ameliorate one or more the disadvantages of the prior art, or at least to provide a useful alternative.

### SUMMARY OF THE INVENTION

The inventors of the present application have surprisingly developed lightweight GO-based aerogel materials which may have a highly porous structures and large surface area making them suitable for adsorption applications. These GO-based aerogels may have high water adsorption capacity with fast adsorption and desorption rates due to their unique physico-chemical properties. Moreover, the desorption process for these aerogel materials may be completed at low temperature (50° C.) or even at room temperature with low humidity.

In a first aspect of the invention there is provided an aerogel comprising graphene oxide which is crosslinked with a metal ion, wherein the metal ion is selected from the group consisting of alkali metal ions, alkaline earth metal ions, transition metal ions and basic metal ions; and wherein said metal ion is not selected from the group consisting of Fe³⁺, C²⁺, Ni²⁺, Cu²⁺, Zr⁴⁺, Sn⁴⁺, Ti⁴⁺, V⁵⁺, La³⁺, Cr³⁺, Al³⁺, Zn²⁺ and Ce⁴⁺.

The following options may be used in conjunction with the first aspect, either individually or in any combination.

The skilled person will understand that the aerogel may be any shape or size, and that its shape and/or size will depend upon the application. It may have, for example, a spherical structure, cubic structure, cylindrical structure, rectangular structure, tube-like structure, or a wire-like structure. In certain specific embodiments the aerogel may be in the form of a sheet, which may, for example, be rolled up to fit into a cylindrical-shaped apparatus. In certain specific embodiments, the aerogel may be in the form of a cake, flakes, or a powder.

The weight ratio of graphene oxide to metal ion may be from about 500:1 to about 1:20, or it may be from about 200:1 to about 1:20, about 100:1 to about 1:20, about 50:1 to about 1:20, about 20:1 to about 1:20, about 200:1 to about 1:10, about 200:1 to about 1:5, about 100:1 to about 1:10, about 50:1 to about 1:5, about 20:1 to about 1:2, about 5:1 to about 1:2, or about 5:1 to about 1:1. In certain specific embodiments, the weight ratio of graphene oxide to metal ion is from about 200:1 to about 1:5. In certain specific embodiments, the weight ratio of graphene oxide to metal ion is from about 5:1 to about 1:1. The weight ratio of graphene oxide to metal ions may be, for example, about 500:1, 200:1, 100:1, 50:1, 20:1, 10:1, 5:1, 2:1, 1:1, 1:2, 1:5, 1:10, or 1:20.

The metal ion may be any ion capable of cross-linking the graphene oxide. In certain embodiments it is selected from alkali metal ions and alkaline earth metal ions, and combinations thereof. In certain alternative embodiments, it is a basic metal ion or a transition metal ion. In certain embodiments, the metal ion is an ion selected from the group consisting of beryllium, magnesium, calcium, strontium, lithium and barium. In certain embodiments, the metal ion may be an iron ion. In certain specific embodiments, the metal ion is selected from the group consisting of: Be²⁺, Mg²⁺, Ca²⁺, Sr²⁺, Li⁺, and Ba²⁺. In certain embodiments, the metal ion is an alkaline earth metal ion. In certain specific embodiments, the alkaline earth metal ion is Ca²⁺.

Without being bound by theory, the inventors of the present application postulate that graphene oxide cross-linked by certain metal ions may provide advantageous adsorption properties in part due to the high hydration number of the cross-linking ions, which attract more water molecules around them, and/or the fast exchange rate of water molecules in the first hydration shell of the respective metal ions, which allow the water molecules to be exchanged rapidly thereby providing a fast adsorption rate for the crosslinked GO aerogels.

The graphene oxide itself (i.e. prior to being crosslinked) is an essentially two dimensional material. The size and shape of the graphene oxide may affect the properties of the aerogel. The graphene oxide may have a mean aspect ratio of at least about 20, or at least about 50, 100, 200, 500, 1000, 2000, 5000, 10⁴, or 10⁵. It may be from about 20 to about 10⁶, or from about 10² to 10⁶, 10³ to 10⁶, 10⁴ to 10⁶, 10⁵ to 10⁶, 20 to 10⁵, 20 to 10⁴, 20 to 10³, 20 to 10², 10² to 10³, 10³ to 10⁴, or 10⁴ to 10⁵. It may be for example about 20, 30, 40, 50, 100, 200, 500, 10³, 5×10³, 10⁴, 5×10⁴, 10⁵, 5×10⁵, or 10⁶. The aspect ratio may be defined as the ratio of the minimum lateral dimension (i.e. in the plane of the graphene oxide) to the average non-lateral dimension (i.e. orthogonal to the plane of the graphene oxide). The graphene oxide may be non-uniform in shape, but on average may have lateral dimension at least 20 times greater than its average non-lateral dimension.

In certain embodiments, the graphene oxide may have an average lateral dimension of less than about 10,000 nm, 5000 nm, 2000 nm, 1000 nm, 500 nm, 200 nm, 100 nm, 50 nm, or less than about 20, 10, 5, 2 or 1 nm. In certain embodiments, an average lateral dimension of the graphene oxide is about 500 nm or less. The graphene oxide may have an average lateral dimension of from about 0.5 nm to about 10,000 nm, or from about 1 to 500, 2 to 500, 5 to 500, 10 to 500, 20 to 500, 0.5 to 200, 0.5 to 100, 0.5 to 50, 0.5 to 20, 2 to 50, 5 to 100, or 10 to 200 nm. It may be for example about 0.5, 1, 2, 5, 10, 20, 50, 100, 200, 500, or 1000 nm. The graphene oxide may comprise particles formed from a number of sheets of laminar material. The average number of individual sheets in each particle may be 1 or may be greater than about 1, or greater than about 2, 3, 4, 5, 6, 7, 8, 9, 10, 15, 20 or 50 sheets. It may be from about 1 sheet to about 1000 sheets, or from about 1 to 500, 1 to 200, 1 to 100, 1 to 50, 5 to 100, 5 to 1000, 10 to 1000, 20 to 1000, 50 to 1000, 5 to 100, 10 to 200, or 20 to 500 sheets. It may be for example about 1, 2, 3, 4, 5, 6, 7, 8, 9, 10, 15, 20, 25, 30, 40, 50, 60, 70, 80, 90, 100, 200, 500, or 100 sheets.

In certain embodiments, the aerogel may comprise a mixture of graphene oxide having different average lateral dimensions. For example, it may comprise a mixture of graphene oxide having an average lateral dimension of about 5 μm, and graphene oxide having an average lateral dimension of about 300 nm (i.e. the graphene oxide may have a bimodal size distribution).

In other embodiments, the graphene oxide may have an average lateral dimension of more than about 200 nm, 500 nm, 1000 nm, 2000 nm, or 5000 nm. In certain embodiments, an average lateral dimension of the graphene oxide is about 500 nm or more. The graphene oxide may have an average lateral dimension of from about 0.2 μm to about 10 μm, or from about 0.5 to 5, 0.5 to 2, 0.5 to 1, 0.2 to 10, 0.2 to 5, or 0.2 to 0.5 μm. It may be for example about 0.5, 1, 2, 5, or 10 μm. The graphene oxide may comprise particles formed from a number of sheets of laminar material. The average number of individual sheets in each particle may be greater than about 20, 30, 40, 50, 60, 70, 80, 90, 100 or 200 sheets. It may be from about 20 sheets to about 1000 sheets, or from about 50 to 500, 50 to 200, 50 to 100, 20 to 50, 20 to 100, 20 to 200, or 20 to 500 sheets. It may be for example about 20, 25, 30, 40, 50, 60, 70, 80, 90, 100, 200, 500, or 1000 sheets.

The graphene oxide may have an average non-lateral dimension (i.e. thickness) of less than about 2000 nm, or less than about 1000, 500, 200, 100, 50, 20, 10, 5, 2, 1, or 0.5 nm. It may be from about 1 to 500, 2 to 500, 5 to 500, 10 to 500, 20 to 500, 0.5 to 200, 0.5 to 100, 0.5 to 50, 0.5 to 20, 2 to 50, 5 to 100, or 10 to 200 nm. It may be, for example, about 0.5, 1, 2, 5, 10, 20, 50, 100, 200, 500, or 1000 nm.

The carbon:oxygen ratio of the graphene oxide may be from about 0.1 to about 5, or about 0.5 to about 5, about 1 to about 4, about 1.5 to about 2.5, or about 2 to about 2.5. It may be, for example, about 0.1, 0.2, 0.5, 1, 1.5, 2, 2.1, 2.2, 2.25, 2.3, 2.35, 2.4, 2.5, 3, 4, or 5. In certain embodiments, the carbon:oxygen ratio of the graphene oxide is from about 0.5 to about 5. In certain specific embodiments, the carbon:oxygen ratio of the graphene oxide is about 2.25.

The adsorption capacity of the aerogel may be from about 5% to about 1000% at 100% relative humidity, or it may be from about 5% to about 500%, about 10% to about 500%, about 20% to about 500%, about 50% to about 500%, about 100% to about 500%, about 20% to about 400%, about 50% to about 300%, about 50% to about 250%, or about 100% to about 250%, at 100% relative humidity. In certain embodiments, the adsorption capacity of the aerogel is from about 20 to about 400% at 100% relative humidity. The adsorption capacity of the aerogel may be, for example, about 5, 10, 15, 20, 50, 75, 100, 110, 120, 150, 200, 250, 300, 400, 500, 600, 700, 800, 900, or 1000% at 100% relative humidity. In certain embodiments, the aerogel has an adsorption capacity of at least about 40% at 100% relative humidity, or it may be at least about 50, 60, 70, 80, 90, 100, 110, 120, 150, or 200% at 100% relative humidity.

The adsorption capacity of the aerogel may be from about 5% to about 500% at 50% relative humidity, or it may be from about 5% to about 200%, about 10% to about 500%, about 20% to about 500%, about 50% to about 500%, about 100% to about 500%, about 20% to about 400%, about 50% to about 300%, about 50% to about 250%, or about 100% to about 250% at 50% relative humidity. In certain embodiments, the adsorption capacity of the aerogel is from about 20 to about 150% at 50% relative humidity. The adsorption capacity of the aerogel may be, for example, about 5, 10, 15, 20, 50, 75, 100, 110, 120, 150, 200, 250, 300, 400, or 500% at 50% relative humidity.

The aerogel may have a density of from about 0.001 g/cm³ to about 0.4 g/cm³, or it may be from about 0.002 g/cm³ to about 0.4 g/cm³, about 0.005 g/cm³ to about 0.4 g/cm³, about 0.005 g/cm³ to about 0.3 g/cm³, about 0.005 g/cm³ to about 0.25 g/cm³, about 0.01 g/cm³ to about 0.2 g/cm³, about 0.02 g/cm³ to about 0.2 g/cm³, or about 0.1 g/cm³ to about 0.2 g/cm³, In certain embodiments, the density of the aerogel is from about 0.005 g/cm³ to about 0.25 g/cm³. The density of the aerogel may be, for example, about 0.001, 0.002, 0.005, 0.01, 0.02, 0.05, 0.1, 0.2, 0.3 or 0.4 g/cm³.

The aerogel may have a porosity of from about 50% to about 99.9%, or from about 60% to about 99.9%, about 60% to about 99%, about 70% to about 99%, about 80% to about 99%, about 90% to about 99.9%, or about 70% to about 95%. In certain embodiments, the porosity of the aerogel is from about 90 to about 99.9%. The porosity of the aerogel may be, for example, about 50, 55, 60, 65, 70, 75, 80, 85, 90, 91, 92, 95, 97, 99, 99.5, or about 99.9%.

In some embodiments, the pore size of the aerogel can range from about 10 nm to about 500 μm. In some embodiments, the average pore size is at least about 20 nm, at least about 50 nm, 100 nm, 200 nm, 300 nm, 400 nm, or 500 nm. In some embodiments, the average pore size is at least about 1 μm, 10 μm, 20 μm, 50 μm, 100 μm, 110 μm, 120 μm, 130 μm, 140 μm, 150 μm, 160 μm, 170 μm, 180 μm, 190 μm, 200 μm, 210 μm, or 220 μm. In some embodiments, the average pore size may be about 500 μm or less, 400 μm or less, 300 μm or less, or 250 μm or less. Typically, the aerogel may have an average pore size from about 100 to about 250 μm, about 110 to about 220 μm, about 120 to about 210 μm, or from about 130 and 200 μm.

In certain embodiments, the metal ion is an Li, Na, K, Rb, Cs, Fr, Be, Mg, Ca, Sr, Ba, Ra, Sc, Y, Lu, Lr, Ti, Zr, Hf, Rf, V, Nb, Ta, Db, Cr, Mo, W, Sg, Mn, Tc, Re, Bh, Fe, Ru, Os, Hs, Co, Rh, Ir, Mt, Ni, Pd, Pt, Ds, Cu, Ag, Au, Rg, Zn, Cd, Hg, Cn, Al, Ga, Ge, In, Sn, Sb, Ti, Pb, Bi, Po, Nh, Fl, Mc, La, Ce, Pr, Nd, Pm, Sm, Eu, Gd, Tb, Dy, Ho, Er, Tm, Yb, or Lv ion, or a combination thereof. In certain specific embodiments, it is a Li, Na, K, Rb, Cs, Fr, Be, Mg, Ca, Sr, Ba, Ra, Sc, Y, Lu, Lr, Hf, Rf, Nb, Ta, Db, Mo, W, Sg, Mn, Tc, Re, Bh, Ru, Os, Hs, Rh, Ir, Mt, Pd, Pt, Ds, Ag, Au, Rg, Cd, Hg, Cn, Ga, Ge, In, Sb, Ti, Pb, Bi, Po, Nh, Fl, Mc, or Lv ion, or a combination thereof.

In certain alternative embodiments, the metal ion is not one or more of a Li, Na, K, Rb, Cs, Fr, Be, Mg, Ca, Sr, Ba, Ra, Sc, Y, Lu, Lr, Ti, Zr, Hf, Rf, V, Nb, Ta, Db, Cr, Mo, W, Sg, Mn, Tc, Re, Bh, Fe, Ru, Os, Hs, Co, Rh, Ir, Mt, Ni, Pd, Pt, Ds, Cu, Ag, Au, Rg, Zn, Cd, Hg, Cn, Al, Ga, Ge, In, Sn, Sb, Tl, Pb, Bi, Po, Nh, Fl, Mc, La, Ce, Pr, Nd, Pm, Sm, Eu, Gd, Tb, Dy, Ho, Er, Tm, Yb, and/or Lv ion.

In a second aspect of the invention there is provided a method for preparing an aerogel, said aerogel comprising graphene oxide which is crosslinked with a metal ion, wherein the metal ion is selected from the group consisting of alkali metal ions, alkaline earth metal ions, transition metal ions and basic metal ions; and wherein said metal ion is not selected from the group consisting of Fe³⁺, C²⁺, Ni²⁺, Cu²⁺, Zr⁴⁺, Sn⁴⁺, Ti⁴⁺, V⁵⁺, La³⁺, Cr³⁺, Al³⁺, Zn²⁺ and Ce⁴⁺, the method comprising the steps of
(a) contacting graphene oxide with a crosslinking agent in the presence of a liquid; and
(b) removing the liquid to form the aerogel.

The following options may be used in conjunction with the second aspect, either individually or in any combination.

The metal ion and/or the aerogel may be as hereinbefore described with respect to the first aspect.

The liquid may be an aqueous liquid, optionally comprising one or more salts. It may comprise water. In certain embodiments, the liquid is substantially water. The liquid may comprise a polar solvent. It may comprise an alcohol. It may comprise one or more volatile organic solvents. It may, for example, comprise ethanol, methanol, acetone, ethyl acetate, dichloromethane, chloroform, or propanol. The liquid may have a boiling point of below about 150° C., measured at 1 atm pressure, or below about 130° C., 110° C., 90° C. or 70° C., measured at 1 atm pressure.

In certain embodiments, removing the liquid is by freeze-drying. The freeze-drying may be performed at from about −100° C. to about −20° C., or from about −80° C. to about −40° C., or about −100, −80, −60, −50, −40, −30, or −20° C. The freeze drying may be performed over a period of from about 1 to about 48 hours, or from about 2 to about 24, about 3 to about 12, about 4 to about 10, or about 2 to about 5 hours. In certain specific embodiments, the freeze-drying step is conducted under conditions of −60° C. temperature, and over a period of from about 2 to about 24 hours. Typically, vacuum levels for freeze drying are between 50 mTorr and 300 mTorr with 100 mTorr to 200 mTorr being the most common range.

In certain embodiments, after the contacting step, the graphene oxide is transferred to a mould prior to the freeze-drying step. The mould may be any shape or size. The skilled person will understand that the mould shape and/or size will depend upon the desired shape and/or size of the aerogel. The graphene oxide cross-linked with the metal ion in a mixture with the liquid may be transferred to a mould, and upon removal of the liquid, the mixture may form an aerogel having substantially the same volume as the mould.

In certain embodiments, the method comprises the steps of providing an aqueous solution of graphene oxide at a predetermined concentration, followed by exposure to a crosslinking agent thereby providing a cross-linked graphene oxide.

In certain embodiments, the crosslinking agent may be added to the aqueous solution of graphene over a period of from about 5 minutes to about 12 hours, or from about 10 minutes to about 6 hours, about 30 minutes to about 5 hours, about 1 hour to about 4 hours, or about 1 hour to about 3 hours. It may be added over a period of about 5 10, 15, 20, 30, 40, or 50 minutes, or about 1, 1.5, 2, 2.5, 3, 4, 5, 6, 7, 8, 9, 10, or 12 hours. In certain specific embodiments, the crosslinking agent is added to the aqueous solution of graphene over a period of from about 10 minutes to about 6 hours.

In certain embodiments, the concentration of graphene oxide in the aqueous solution is from about 0.01 wt. % to about 30 wt. %, or about 0.02 wt. % to about 30 wt. %, about 0.05 wt. % to about 30 wt. %, about 0.05 wt. % to about 20 wt. %, about 0.05 wt. % to about 10 wt. %, about 0.05 wt. % to about 5 wt. %, about 0.05 wt. % to about 1 wt. %, or about 0.05 wt. % to about 1.5 wt. %. In certain specific embodiments, the concentration of graphene oxide in the aqueous solution is from about 0.01 to about 20 wt. %. In certain specific embodiments, the concentration of graphene oxide in the aqueous solution is from about 0.05 to about 5 wt. %. The concentration of graphene oxide in the aqueous solution may be about 0.01, 0.02, 0.05, 0.1, 0.2, 0.5, 1, 2, 5, 10, 20, or 30 wt. %. In certain specific embodiments, the concentration of graphene oxide in the aqueous solution is about 1 wt. %.

In certain embodiments, the crosslinking agent includes an alkaline earth metal ion and/or an alkali metal ion. In certain specific embodiments, the alkaline earth metal ion and/or alkali metal ion is selected from the group consisting of: beryllium, magnesium, calcium, strontium, lithium and barium. In certain embodiments, the crosslinking agent is selected from the group consisting of: CaCl₂) and MgCl₂. In certain embodiments, the crosslinking agent is a salt of the metal ion as hereinbefore described with respect to the first aspect.

In certain embodiments, after the removing step, the aerogel is compressed. It may be compressed to 95% or less of its original volume, or to 90, 85, 80, 75, 70, 65, 60, 55, 50, 45, or 40% or less of its original volume. It may be compressed to about 95, 90, 85, 80, 75, 70, 65, 60, 55, 50, 45, 40, 35, 30, 25, or 20% of its original volume. In certain specific embodiments, the aerogel is compressed to about 50% of its original volume. It may be compressed by subjecting it to a pressure of from about 0.01 bar to about 5 bar, or from about 0.01 bar to about 2 bar, about 0.02 bar to about 1.5 bar, about 0.05 bar to about 1 bar, about 0.05 bar to about 0.5 bar, or about 0.05 bar to about 0.1 bar. It may, for example, be subjected to a pressure of about 0.01, 0.02, 0.05, 0.1, 0.2, 0.5, 1, 2, 3, 4, or 5 bar.

In a third aspect of the invention there is provided a graphene oxide aerogel produced according to the method of the second aspect.

In certain embodiments, the graphene oxide aerogel may be as hereinbefore described with respect to the first aspect.

In a fourth aspect of the invention there is provided a method to adsorb moisture from a gas stream or an atmosphere laden with said moisture, the method comprising the step of contacting said gas stream or said atmosphere with a graphene oxide aerogel, thereby to adsorb said moisture from said gas stream or said atmosphere.

The gas stream or atmosphere may be a waste gas stream. In certain alternative embodiments it may be an inlet stream for a process, particularly where removing water vapour from the inlet stream is advantageous.

In certain embodiments, the aerogel may be housed in a porous packaging, which allows moisture to pass therethrough. The packaging may be used for a storage application, such as, for example, the storage of a dry food substance.

In certain embodiments, the graphene oxide aerogel is the aerogel according to the first or third aspect.

In a fifth aspect of the invention there is provided use of a graphene oxide aerogel to adsorb moisture from a gas stream. The gas stream may be a waste gas stream. In certain alternative embodiments it may be an inlet stream for a process, particularly where removing water vapour from the inlet stream is advantageous.

In certain embodiments, the graphene oxide aerogel is the aerogel according to the first or third aspect.

In a sixth aspect of the invention there is provided a method of desorbing water adsorbed onto a graphene oxide aerogel, the method comprising the step of sufficiently heating said graphene oxide aerogel thereby releasing said adsorbed water and regenerating said graphene oxide aerogel.

The heating may be at a temperature of from about 30° C. to about 250° C., or about 40° C. to about 250° C., about 40° C. to about 200° C., about 40° C. to about 150° C., about 40° C. to about 100° C., about 40° C. to about 80° C., or about 40° C. to about 60° C. It may be, for example, at a temperature of about 30, 40, 50, 60, 70, 80, 90, 100, 110, 120, 150, 200, or 250° C. In certain embodiments, the heating may be at room temperature.

The heating may be for a period of time from about 10 minutes to about 48 hours, or from about 20 minutes to about 48 hours, about 30 minutes to about 48 hours, about 60 minutes to about 48 hours, about 10 minutes to about 24 hours, about 10 minutes to about 12 hours, about 10 minutes to about 8 hours, about 10 minutes to about 6 hours, or about 30 minutes to about 8 hours. It may be, for example, for about 10, 20, 30, 40, or 50 minutes, or for about 1, 2, 4, 6, 8, 10, 12, 14, 16, 18, 20, 24, 36, or 48 hours.

In certain embodiments, the graphene oxide aerogel is the aerogel according to the first or third aspect.

In a seventh aspect of the invention there is provided a method of recovering water from a graphene oxide aerogel having water adsorbed thereto, the method comprising the step of sufficiently heating said graphene oxide aerogel thereby releasing said adsorbed water, and recovering said water.

The heating may be at a temperature of from about 30° C. to about 250° C., or about 40° C. to about 250° C., about 40° C. to about 200° C., about 40° C. to about 150° C., about 40° C. to about 100° C., about 40° C. to about 80° C., or about 40° C. to about 60° C. It may be, for example, at a temperature of about 30, 40, 50, 60, 70, 80, 90, 100, 110, 120, 150, 200, or 250° C. In certain embodiments, the heating may be at room temperature.

The heating may be for a period of time from about 10 minutes to about 48 hours, or from about 20 minutes to about 48 hours, about 30 minutes to about 48 hours, about 60 minutes to about 48 hours, about 10 minutes to about 24 hours, about 10 minutes to about 12 hours, about 10 minutes to about 8 hours, about 10 minutes to about 6 hours, or about 30 minutes to about 8 hours. It may be, for example, for about 10, 20, 30, 40, or 50 minutes, or for about 1, 2, 4, 6, 8, 10, 12, 14, 16, 18, 20, 24, 36, or 48 hours.

The method may comprise a step of cooling a water vapour produced by the heating process. The cooling may be performed at a temperature of about 90° C. or less, or 80, 70, 60, 50, 40, 30, 20, 10, 0, −10, −20, or −30° C. or less.

In certain embodiments, the graphene oxide aerogel is the aerogel according to the first or third aspect.

In an eighth aspect of the invention there is provided an atmospheric water generator comprising a graphene oxide aerogel.

In certain embodiments, the atmospheric water generator comprises an inlet for introducing a gas stream or atmosphere therein such that the gas stream or atmosphere contacts the graphene oxide aerogel. The gas stream or atmosphere may comprise moisture, and the graphene oxide aerogel may adsorb the moisture from the gas stream or atmosphere.

In certain embodiments, the atmospheric water generator further comprises a heating element to heat the graphene oxide aerogel and release the moisture adsorbed thereon. In certain embodiments, the atmospheric water generator further comprises a cooling element to cool and condense the moisture released in the heating process to form water. The atmospheric water generator may further comprise a container for collecting the condensed water.

In certain embodiments, the graphene oxide aerogel is the aerogel according to the first or third aspect.

### BRIEF DESCRIPTION OF THE DRAWINGS

FIG. 1 shows an example GO/Ca²⁺ solution (˜30 mL) that has been transferred into a glass petri dish with a diameter of 10 cm for a freeze-drying process (a) top-view; (b) side view.

FIG. 2 shows an example GO-based aerogel drying in a freeze-dryer.

FIG. 3 shows a schematic of an example adsorption measurement setup for a laboratory scale.

FIG. 4 shows an example adsorption setup used for a laboratory.

FIG. 5 shows example synthesized GO-based aerogel from a GO solution with lateral dimension (a) >500 nm, and (b)<500 nm. (c) is an AFM image of the GO nanosheets.

FIG. 6 shows images of example GO-based aerogel having a different weight ratio of GO to Ca²⁺: a) 1:1; and b) 5:1.

FIG. 7 shows the water adsorption rate of GO-based aerogels with different weight ratios of GO to cross-linker: (a) GO:Ca²⁺=100:1; (b) GO:Ca²⁺=50:1; (c) GO:Ca²⁺=10:1; (d) GO:Ca²=5:1; and (e) GO:Ca²⁺=1:1.

FIG. 8 shows the schematic design of the canister for a GO-based aerogel compression test.

FIG. 9 shows the 3D-printed canister which was used for the aerogel compression test with its volume scale. The volume of GO-based aerogel in the canister was 300 cm³ without compression.

FIG. 10 shows an example GO-based aerogel after compression by high pressure (1.5 bar) to a thin film.

FIG. 11 shows the adsorption capacity rate of example GO aerogels: (a) without compression, (b) with a compression of 0.07 bar.

FIG. 12 shows the adsorption rate of example GO-based aerogels with different concentration of GO solution and weight ratio of crosslinker: (a) 1 wt %, GO:Ca²⁺1:1; (b) 1.5 wt %, GO:Ca²⁺1:1; and (c) 1.5 wt %, GO:Ca²⁺2:1.

FIG. 13 shows the adsorption rate of an example GO-based aerogel under (a) 100% RH; (b) 80% RH; (c) 70% RH; and (d) 50% RH.

FIG. 14 shows the relationship between adsorption capacity and relative humidity of: (a) an example GO aerogel, (b) an example GO aerogel with 50% volume reduction and (c) silica gel.

FIG. 15 shows the relationship between density, RH and adsorption capacity of example GO-based aerogels: (a) no compression, (b) 50% volume reduction; and (c) 75% volume reduction.

FIG. 16 shows the adsorption rate of eGO-based aerogel after 4 cycles.

FIG. 17 shows a schematic illustration of an example desorption process.

FIG. 18 shows an example experimental setup for a desorption test at a lab-scale.

FIG. 19 shows the adsorbed water can be re-collected using a simple example desorption process.

FIG. 20 shows: (a) the components of an example prototype; and (b) an example mould module for GO-based aerogel preparation.

FIG. 21 shows an example 3D-printed mould module for GO aerogel preparation.

FIG. 22: Illustration of the laboratory scale production of example GO aerogels: (a) graphene oxide suspension crosslinked with a metal ion, (b) freeze-drying the crosslinked GO suspension, and (c) the formation of the GO aerogel.

FIG. 23: Influence of GO flake size on the adsorption performance of example aerogels (GO:Ca²⁺1:1). Aerogel samples were prepared by using different GO flake sizes: (a) ˜5 μm (relative humidity ˜80%, highest capacity ˜72.9%), (b) ˜1 μm (relative humidity ˜90%, highest capacity ˜123.9%), and (c) ˜300 nm (relative humidity ˜90%, highest capacity ˜123.3%).

FIG. 24: Adsorption performance of example GO-aerogels prepared using a mixture of GO flakes with different sizes (˜5 μm and ˜300 nm) at the ratio of: (a) 100:0 (highest capacity 72.9%), (b) 75:25 (highest capacity 33.3%), (c) 50:50 (highest capacity 100.9%), and (d) 25:75 (highest capacity 38.4%). Experimental condition: GO:Ca²⁺=1:1, and humidity=80%.

FIG. 25: A comparison of adsorption performance of example aerogels at different humidity: (a) 90% (highest capacity ˜123.3%), (b) 75% (highest capacity ˜68.5%), (c) 60% (highest capacity ˜42.7%), and (d) 50% (highest capacity ˜37.6%). Aerogel was generated from GO flakes with ˜300 nm of lateral size.

FIG. 26: A comparison of adsorption performance of example GO aerogel at different humidity: (a) 90% (highest capacity ˜123.9%), (b) 75% (highest capacity ˜94.4%), (c) 60% (highest capacity ˜62.9%), (d) 50% (highest capacity ˜39.4%), (e) 40% (highest capacity ˜23.4%) and (f) 30% (highest capacity ˜15.3%).

FIG. 27: Relationship between the relative humidity and the adsorption performance of example GO aerogel prepared by using Ca²⁺ crosslinker. The inserted arrow shows the decreasing trend of adsorption capacity (%). The adsorption capacity at 100 min was used for the comparison plot.

FIG. 28: Adsorption performance of GO aerogel crosslinked with different metal ions: (a) Ca²⁺ (relative humidity: ˜80%; highest capacity ˜124%), (b) Al³⁺ (relative humidity: ˜90%; highest capacity ˜107.9%) (c) Mg²⁺ (relative humidity: ˜75%; highest capacity ˜42%), and (d) K⁺ (relative humidity: ˜80%; highest capacity ˜30%). GO:Crosslinker=2:1.

FIG. 29: Adsorption performance of GO aerogel crosslinked with different metal ions: (a) Ca²⁺ (highest capacity ˜120.9%), (b) Li⁺ (highest capacity ˜96%), and (c) Fe³⁺ (highest capacity ˜72.5%). GO:Crosslinker=1:1, Relative humidity=75-90%.

FIG. 30: GO-aerogel in flake form with ˜2 cm diameter prepared by scissor cutting.

FIG. 31: A comparison of adsorption performance of example GO-aerogels having different shapes: (a) cake, (b) powder, and (c) flake (˜2 cm diameter) forms. GO:Ca²⁺=1:1, Relative humidity=˜90%.

FIG. 32: Adsorption performance of example eGO at different relative humidity (RH): (a) 100%, (b) 80-85%, and (c) 75-80%. (d) The comparison curve for adsorption capacity of example eGO at different humidity.

FIG. 33: Multiple adsorption cycles of example eGO: A) 1^{st} cycle; B) 2^{nd} cycle; C) 3^{rd} cycle; D) 4^{th} cycle; E) 5^{th} cycle; F) 6^{th} cycle; G) 7^{th} cycle; H) 8^{th} cycle. eGO:Ca²⁺=1:1, Relative humidity=˜100%.

FIG. 34: A comparison plot of adsorption capacities of aerogel prepared by eGO (a) and eGO made in Armidale (b). eGO:Ca²⁺=1:1, Relative humidity=˜85-90%.

FIG. 35: Adsorption performance of eGO-UNE aerogels: (a) Sample 1 (highest capacity ˜177%), and (b) Sample 2 (highest capacity ˜125%). eGO:Ca²⁺=1:1, Relative humidity=˜90-95%.

FIG. 36: Step-by-step preparation of example GO aerogel on a large scale for freeze-drying. (a) Crosslinked GO suspension loaded in the metal trays (19 cm×35 cm×3 cm), (b-e) stacking trays inside a −80° C. freezer, and (f-h) visualization of frozen samples.

FIG. 37: Adsorption performance of example GO aerogel on large-scale at 85-95% humidity: (a) 1^{st} batch aerogel (˜10.97 g), (b) 2^{nd} batch aerogel (˜8.22 g), (b) 3^{rd} batch aerogel (˜10.12 g). RH 90%; GO:Ca²⁺=1:1.

FIG. 38: Adsorption performance of GO aerogel on small scale (˜0.4 g) from 2^{nd} batch sample. GO:Ca²⁺=1:1, Relative humidity=85-95%.

FIG. 39: Adsorption performance of example aerogels (concentration 1 wt. %) having different GO to crosslinker wt. ratios: (a) 100:1, (b) 50:1, (c) 10:1, (d) 5:1, and (e) 1:1, at relative humidity in the range of 95 to 100%. (f) Comparison plot presenting the increasing adsorption performance with increasing the crosslinker ratio; the plot was according to the measurement at 600 min. The arrow represents the increasing trend of adsorption performance of GO aerogel.

FIG. 40: Adsorption performance of example GO aerogel with varying thickness by using external pressure: (a) ˜0.07 bar, (b) ˜1.5 bar, and (c) ˜10 bar. (d) The design of the canister for compression of GO aerogel (left) and the 3D printed canister containing GO aerogel for compression (right). Relative humidity: ˜95-100%.

FIG. 41: Analysis of the influence of ultrasonication during sample preparation on the performance of GO-aerogel. (a) No sonication was applied during sample preparation, and (b) ultrasonication was applied for 10 min during sample preparation. GO:Ca²⁺=2:1, relative humidity=˜95-100%

FIG. 42: Adsorption performance of example GO-aerogel (1.5 wt. %) at different humidity: (a) ˜95-100%, (b) ˜80%, (c) ˜70%, and (d) ˜50%. Aerogel samples were prepared by crosslinking with Ca²⁺ at the weight ratio of 2:1 GO to crosslinker.

FIG. 43: Isotherm spectra of example GO aerogel: (a) sorption isotherm (atm); (b) sorption isotherm (vacuum); (c) quick re-sorption when vented. Adsorption was performed at 85% humidity, and Desorption was tested under two different conditions: atmospheric pressure and vacuum. The desorption tests by both techniques were undertaken at ambient temperature. Grey highlighted area represents the isotherm under vacuum. Sample weight: 2.7 g, room temperature, RH: 85%.

FIG. 44: Isotherm spectra of example GO aerogel: (a) adsorption; (b) desorption. Sample mass=˜8.57 g, relative humidity=85%, and the desorption test was under dried air at 30° C.

FIG. 45: Isotherm curve of GO-aerogel: (a) adsorption; (b) desorption. Sample mass=˜3.73 g, relative humidity=85%, and the desorption test was under dried air at 40° C.

FIG. 46: Isotherm curve of GO-aerogel: (a) adsorption; (b) desorption. Sample mass=2.91 g, relative humidity=55%, and the desorption test was under dried air at 40° C.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Unless the context clearly requires otherwise, throughout the description and the claims, the terms “comprise”, “comprising”, and the like are to be construed in an inclusive sense as opposed to an exclusive or exhaustive sense; that is to say, in the sense of “including, but not limited to”. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of” In other words, with respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The terms “predominantly”, “predominant”, and “substantially” as used herein shall mean comprising more than 50% by weight, unless otherwise indicated.

As used herein, with reference to numbers in a range of numerals, the terms “about,” “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “aerogel” means a porous material derived from a gel, in which a liquid component of the gel has been replaced with a gas without significant collapse of the gel structure. In certain embodiments, in particular when the material comprises graphene oxide, it means a material having a density of less than about 0.5 g/cm³, or less than about 0.2 g/cm³, about 0.1, or about 0.05 g/cm³.

As used herein, the term “gel”, means a soft, solid or solid-like material consisting of two or more components, one of which is a liquid, that are present in substantial quantity.

As used herein, the term “crosslinked” with respect to graphene oxide, means that two or more graphene oxide sheets are joined together through a bond, or a series of bonds through a crosslinking group, wherein the crosslinking group is not itself a component of the graphene oxide sheets. In certain embodiments, the cross linking group is a metal ion.

As used herein, the term “lateral dimension” with respect to graphene oxide refers to the average width and length of a graphene oxide sheet in the plane of the sheet. That is, a dimension that is orthogonal to the sheet thickness.

As used herein the term “adsorption capacity” with respect to an aerogel can be calculated according to the equation below.

$$Adsorption capacity = \frac{{Weight}_{Adsorbed water}}{{Weight}_{Dry Aerogel}} \times 100 \%$$

where Weight_{Adsorbed water} is the weight of adsorbed water, which can be obtained by the change in the weight of the aerogel after exposure to moisture, which can be calculated as follows:

$${Weight}_{Adsorbed water} = {Weight}_{Saturated Aerogel} - {Weight}_{Dry Aerogel}$$

where Weight_{saturated Aerogel} is the weight of aerogel after adsorbing the moisture such that it is saturated. Weight_{Dry Aerogel} is the initial weight of the dry aerogel.

As used herein the term “adsorption”, or “adsorb”, or “adsorbed” is to be construed broadly, and includes any process whereby a water molecule may be sorbed onto or into the aerogel, including, for example, adsorption and/or absorption processes.

As used herein, the term “basic metal” should be construed as including any metals in Group 13-16 of the periodic table, including Al, Ga, Ge, In, Sn, Sb, Tl, Pb, Bi, Po, Nh, Fl, Mc, and Lv.

As used herein, the term “transition metal” should be construed as including any metals in Groups 3-12 of the periodic table, including Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs, Mt, Ds, Rg, Cn, lanthanides and actinides.

### Abbreviations

AFM: atomic force microscopy; DI: deionised; eGO: electrochemically exfoliated graphene oxide; GO: graphene oxide; ICP-MS: inductively coupled plasma mass spectrometry; RH: relative humidity.

Preferred features, embodiments and variations of the invention may be discerned from the following Examples which provides sufficient information for those skilled in the art to perform the invention. The following Examples are not to be regarded as limiting the scope of the preceding Summary of the Invention in any way.

### Examples

### Preparation of Graphene Oxide-Based Aerogel

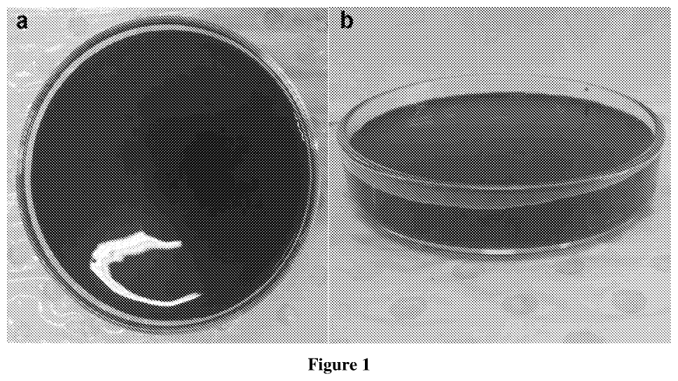

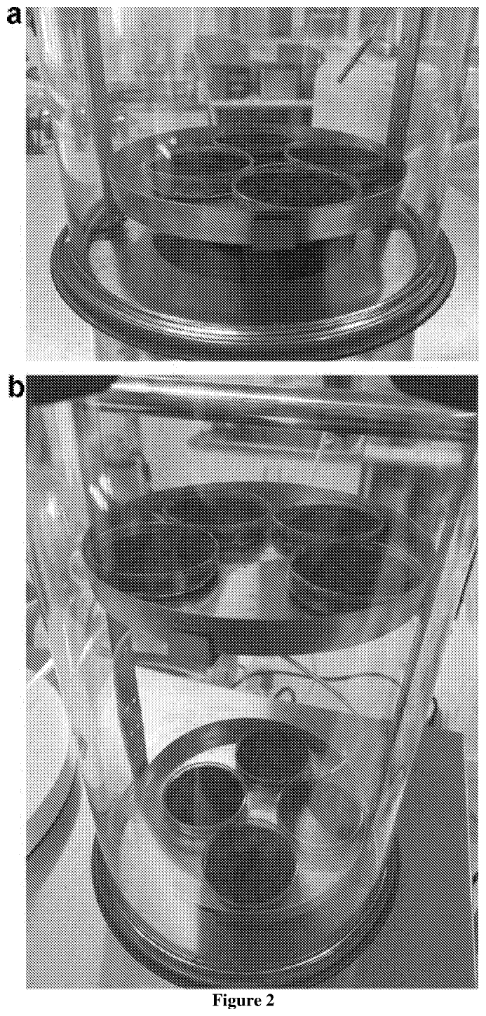

The graphene oxide-based aerogel was prepared by cross-linking graphene oxide with calcium ion (CaCl₂)) and freeze-drying the resultant cross-linked graphene oxide. The detailed experimental procedure is described as follows.
1. A graphene oxide solution with a certain concentration was prepared.
2. A CaCl₂) stock aqueous solution having a concentration of 10 wt % was prepared. The CaCl₂) solution for aerogel preparation could be diluted in DI water to different concentrations for improved mixing (this may be optional for large-scale aerogel formation).
3. The CaCl₂) solution with a certain weight ratio was gradually added to the GO solution with constant stirring for 30 min.
4. The GO/Ca²⁺ solution was then transferred to a mould (see, e.g., FIG. 1) for the freeze-drying process (as shown, for example, in FIG. 2) to form the GO-based aerogel.

### Adsorption Capacity Measurement Setup

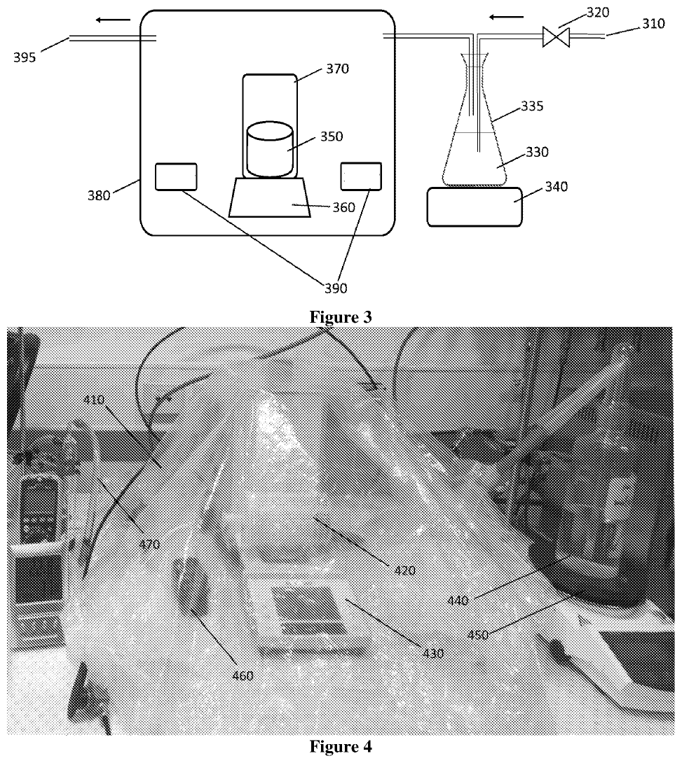

The adsorption capacity of the GO-based aerogels was measured in a plastic glove bag. As shown in FIGS. 3 and 4, the glove bag (380 and 410) was connected with a flask (335 and 440) filled with water (330) for increasing the humidity. The relative humidity (RH) inside the glove bag was influenced by the moisture flow rate and temperature, which were controlled using the inlet valve (320, located near the inlet 310) and the heater (340 and 450). The balance (360 and 430) was placed in the glove bag for continuously recording the weight change of the aerogel (350 and 420) in cage 370. Two humidity sensors (390 and 460) were used for monitoring the relative humidity in the glove bag. The glove bag was connected to an outlet (395 and 470) through which the vapour could exit the bag.

Atmospheric air entered the apparatus through the inlet 310 via the inlet valve 320 and passed through the water 330 in flask 335 and into the glove bag 380 before exiting through the outlet 395. The water 330 was be heated using heater 340. Sensors 390 measured the relative humidity in the glove bag that the aerogel sample 350 in cage 370 was exposed to. A balance 360 was used to measure the change in mass of the aerogel 350.

### Adsorption Capacity Calculation

The adsorption capacity of the GO-based aerogel was calculated based on the change of weight of the aerogel. When the aerogel started to adsorb the moisture, its weight increased. The aerogel with adsorbed water molecules reached a maximum weight when it was saturated. The adsorption capacity was calculated according to the equation as follows.

$$Adsorption capacity = \frac{{Weight}_{Adsorbed water}}{{Weight}_{Dry Aerogel}} \times 100 \%$$

where Weight_{Adsorbed water} is the weight of adsorbed water, which can be obtained by the change in the weight of aerogel, which itself can be calculated as follows:

$${Weight}_{Adsorbed water} = {Weight}_{Saturated Aerogel} - {Weight}_{Dry Aerogel}$$

where Weight_{Saturated Aerogel} is the weight of aerogel in a saturated form after adsorbing a maximum amount of moisture. Weight_{Dry Aerogel} is the initial weight of the aerogel in a dry form.

### Adsorption Capacity of GO-Based Aerogel

The adsorption capacity of GO-based aerogel was significantly affected by the physicochemical properties of GO used for aerogel preparation. The lateral dimension, C/O ratio and the concentration of GO affected the formation of GO-based aerogel, leading to different adsorption capacity with different morphology of GO-based aerogel.

The cross-linker, Ca²⁺ (CaCl₂)), was used for enhancing the mechanical properties of GO-based aerogel. The weight ratio of Ca²⁺ to GO was also an important factor that resulted in variation of performance. The weight ratio was adjusted according to the concentration of GO solution. The concentration of GO solution affected the formation process of GO-based aerogel, leading to different adsorption capacity aerogels.

Some external factors, such as the applied compression and relative humidity may also play important roles in the adsorption capacity of GO-based aerogels. To reduce the aerogel volume, the GO-based aerogel was compressed under different pressures. There was a threshold pressure for maintaining the capacity of GO-based aerogel. High compression could damage the microstructure of GO-based aerogel and reduce its the desiccant capacity.

The GO-based aerogel was found to have different adsorption capacity under different relative humidity conditions. Generally, the adsorption capacity of GO-based aerogel was increased under high relative humidity and decreased under low relative humidity.

### The Effect of Lateral Dimension of GO

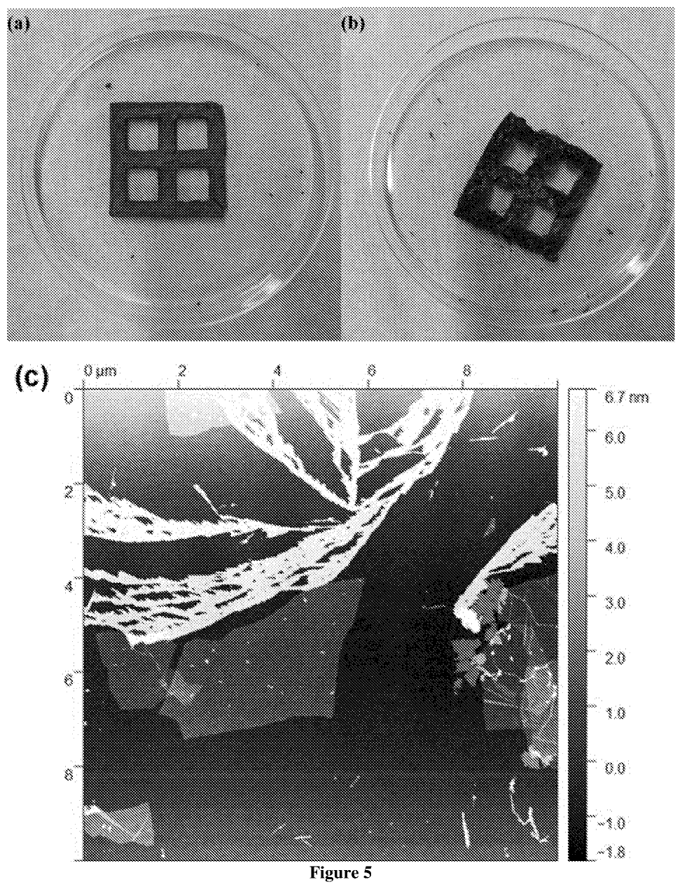

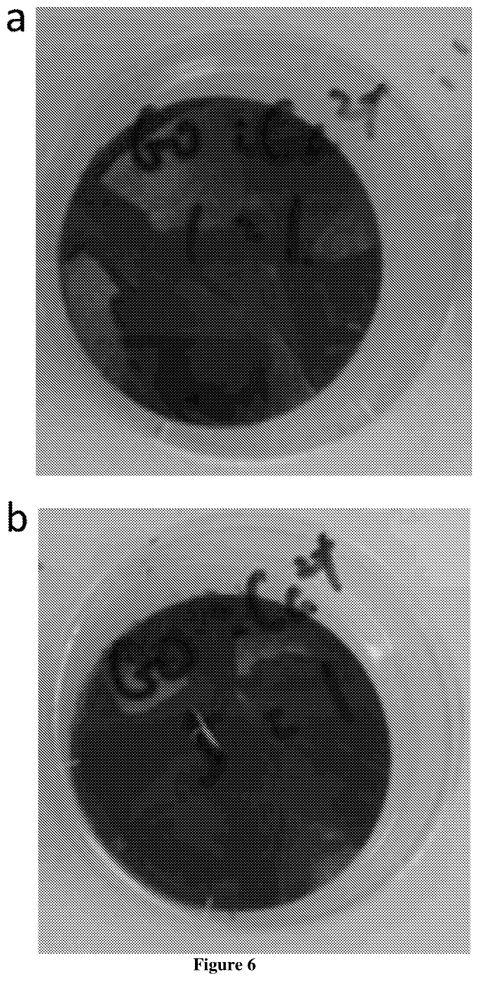

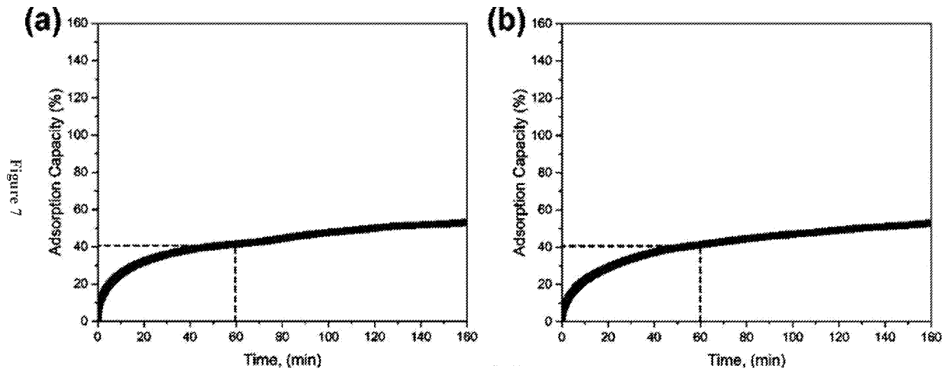

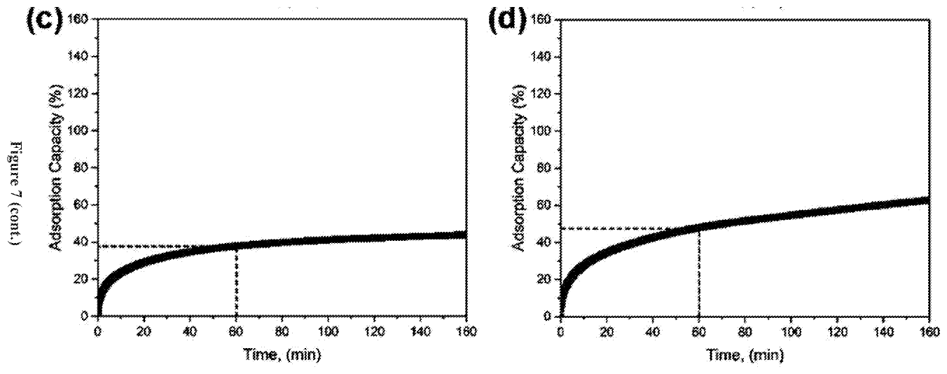

The lateral dimension of GO, which can be tuned through pre-treatment or post-treatment of the synthesis process was an important parameter to adjust the properties of the GO-based aerogel. The C/O ratio of GO used was about 2.25. FIG. 5 shows the GO-based aerogel formed using GO solutions with different lateral dimensions. FIG. 5a shows that the GO with a lateral dimension >500 nm provided a uniform morphology of aerogel. The aerogel using GO solution having a GO lateral dimension <500 nm had a porous structure, which could potentially increase the active sites for adsorbing water molecules. FIG. 5c shows the atomic force microscopy (AFM) image of GO nanosheets with different lateral dimensions.

The adsorption measurements of these two aerogels were determined. Table 1 shows how GO lateral dimension affected the aerogel properties. Multiple adsorption cycles showed the stability of the GO aerogels. The GO-based aerogel with small lateral dimension showed a better performance in its stability and adsorption capacity, although the larger lateral dimension GO aerogel still had reasonable properties.

TABLE 1
The GO lateral dimension effect on the aerogel properties.
RH used for the experiments ranged from 90-100%.

| GO | | Weight of | Number of |
|---|---|---|---|
| dimension, | Weight ratio | dry GO | Cycles/Average |
| nm | of GO:Ca²⁺ | aerogel, g | adsorption capacity |
| >500 | 10:1 | 0.0351 | 3/50.02% |
| <500 | 10:1 | 0.1428 | 2/61.49% |

Note:
the concentration of the GO solution was 1 wt. % in aqueous solution.

### The Weight Ratio of GO to Ca²⁺

The GO used for the following experiments had a lateral dimension <500 nm. As shown in FIG. 6, there was no obvious difference in the morphology of aerogel when a different weight ratio of Ca²⁺ was used (FIG. 6 shows a GO:Ca²⁺ ratio of a) 1:1; and b) 5:1). However, the weight ratio of Ca²⁺ affected the adsorption capacity of the GO-based aerogels. The adsorption capacity of the GO-based aerogels first exhibited a decrease from 81% to 58% when the weight ratio of GO to Ca²⁺ was varied from 100:1 to 10:1. The adsorption capacity of the GO-based aerogels significantly increased to 258% when the weight ratio of GO to Ca²⁺ was increased to 1:1. Table 2 shows the adsorption capacity of GO-based aerogels with different weight ratio of cross-linker. The lateral dimension of the GO used was <500 nm, and the RH ranged from 90-100%.

TABLE 2
Adsorption capacity of GO-based aerogels with different weight ratio
of cross-linker measured with the RH ranging from 90-100%.

| Weight ratio | Weight of dry | Adsorption |
|---|---|---|
| of GO:Ca²⁺ | GO aerogel, g | Capacity |
| 100:1 | 0.1244 | 81.43% |
| 50:1 | 0.1284 | 67.13% |
| 10:1 | 0.1428 | 58.40% |
| 5:1 | 0.1293 | 105.49% |
| 1:1 | 0.1287 | 258.19% |

Note:
the concentration of GO solution was 1 wt % in an aqueous solution.

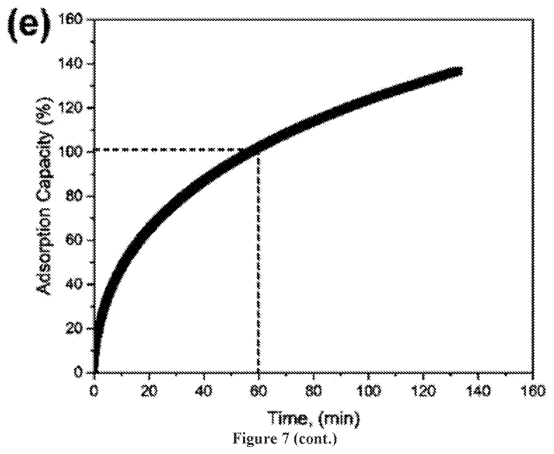

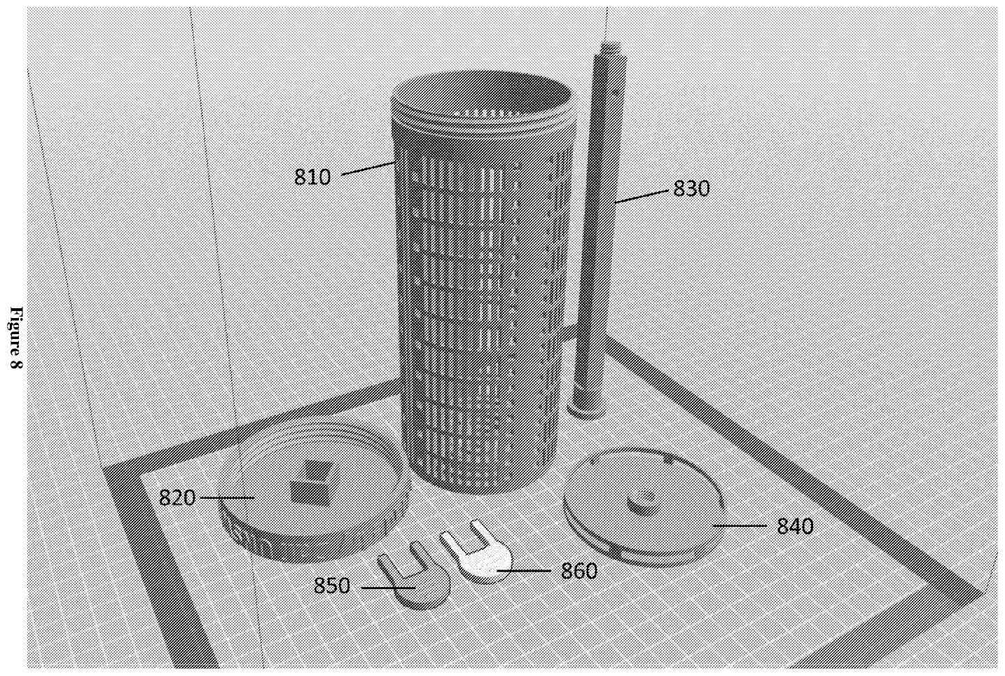

FIG. 7 shows the adsorption rate of GO-based aerogel with different weight ratio of GO to Ca²⁺. When the GO to Ca²⁺ weight ratio ranged from 100:1 to 5:1 (FIG. 1(a)-(d)), the adsorption rate did not change significantly. Within 60 min, the adsorption capacity reached around 40%. However, the GO-based aerogel with a GO to Ca²⁺ weight ratio of 1:1 had an adsorption capacity of 258% and a faster adsorption rate than the other aerogels. As shown in FIG. 6(e), the adsorption capacity of the 1:1 GO-based aerogel reached 102% within 60 min.

### Compression Effect on GO-Based Aerogel

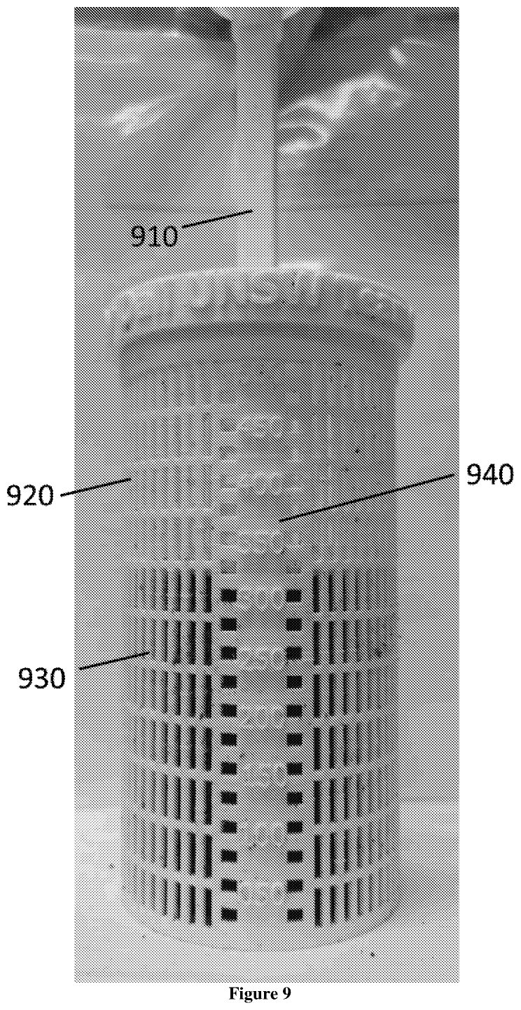

The adsorption capacity of GO-based aerogel with or without compression applied was measured. The GO-based aerogel was compressed to save the space during the packing process for commercialization. A canister for the compression test was designed as shown in FIG. 8. The components of the canister include the outer body 810, plunger arm 830, plunger plate 840, lid 820, and components 850 and 860 for fixing the position of the plunger plate in use. To assemble the canister, the plunger arm 830 is threaded through the square hole in the lid 820 and screwed into plunger plate 840. The plunger arm and plunger plate assembly is inserted into outer body 810, and the lid 820 is screwed in place in the thread at the top of outer body 810. The canister was designed for an aerogel with a diameter of 10 cm. After packing the aerogel into the canister, the aerogel can be compressed by applying pressure to the plunger arm to reduce the volume according to the volume scale on the outer body 810 of the canister. The plunger plate 840 is then fixed by inserting components 850 and 860 through openings in the outer body 810 of the canister and into the side apertures of the plunger plate 840 to hold it in position and keep the aerogel in a compressed form. FIG. 9 shows a GO-based aerogel 930 with a volume of 300 cm³ in the 3D-printed canister without compression applied. The plunger arm 910, and outer body 920, including volume scale 940 are shown.

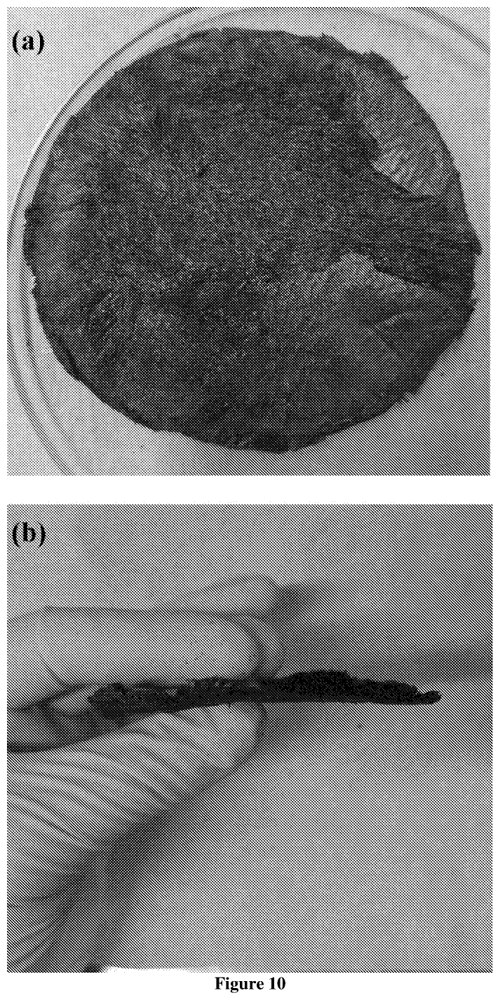

Table 3 shows the adsorption performance of GO-based aerogels under different compression forces. Moderate compression does not appear to harm the adsorption capacity of the GO-based aerogels. For example, when there is a 48% reduction in volume, the adsorption capacity does not decrease at all compared to the uncompressed aerogel. However, there is a threshold pressure for maintaining the capacity of GO-based aerogels. High compression could damage the microstructure of GO-based aerogels and reduce its capacity. For example, when high pressure was applied to compress the aerogel to a thin film as shown in FIG. 10, the adsorption capacity reduced by half (Table 3).

TABLE 3
The performance of GO-based aerogel with RH from 90-100% with/without
compression (Lateral dimension of GO: <500 nm).

| Weight | Weight | Density of | | Volume of | |
|---|---|---|---|---|---|
| ratio of | of GO | GO aerogel, | Adsorption | GO aerogel, | |
| GO:Ca²⁺ | aerogel, g | g/cm³ | Capacity | cm³ | Compression |
| 1:1 | 1.7471 | 0.0182 | 157% | ~96 | N |
| 1:1 | 1.6215 | 0.0324 | 164% | ~96 | ~0.07 bar |
| 1:1 | 4.342 | ~1.4382 | 83.3% | ~160 | (reduce to 50 |
| | | | | | cm³) |
| | | | | | 1.5 bar (like |
| | | | | | a thin film) |

Note:
(1) the concentration of GO solution was 1 wt % in aqueous solution. (2) The adsorption capacity of the aerogel may also be influenced by other external factors, such as the packing, the effective contact area and flow rate. The large-scaled GO-based aerogel was used for the compression test and the adsorption capacity was stable at around 150-160%.

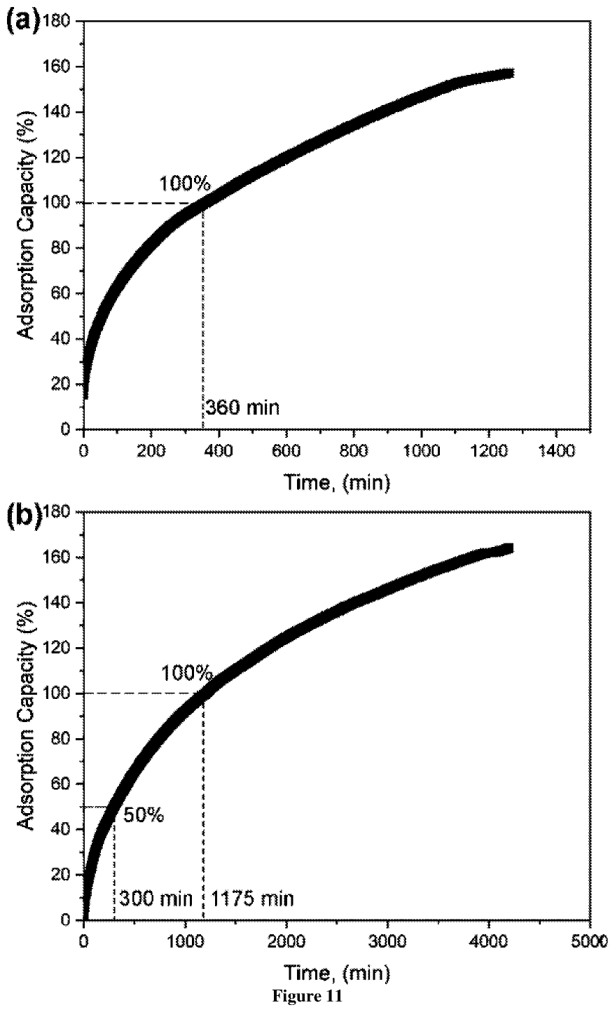

FIG. 11 shows the adsorption rate of GO-based aerogel without or with compression. These two GO-based aerogels had a similar maximum adsorption capacity. Compared with the aerogel without compression (FIG. 11a), the rate of adsorption for the GO-based aerogel compressed by 0.07 bar was reduced. However, it was still able to achieve a 50% adsorption capacity within 300 min (FIG. 11b).

### The Concentration of GO Solution

The concentration of GO solution used for aerogel preparation can affect the efficiency of the mixing with the cross-linker and the adsorption capacity of the resultant aerogel. The weight ratio of GO to cross-linker could be adjusted depending upon the concentration of GO solution used. A GO solution with a concentration of 1.5 wt % was investigated. Compared with aerogels formed from a GO solution having a concentration of 1 wt %, a GO to Ca²⁺ weight ratio of 2:1 resulted in the aerogel having a comparable adsorption capacity of 154% as shown in Table 4. The lateral dimension of the GO solutions with different concentrations was <500 nm, and the adsorption testing was performed at 100% RH.

TABLE 4
The effect of the concentration of GO solution
on the adsorption capacity of GO-based aerogel.

| Concentration of GO | Weight ratio of | Adsorption | |
|---|---|---|---|
| solution | GO:Ca²⁺ | Capacity | Compression |
| 1 wt % | 1:1 | 157% | N |
| 1.5 wt % | 1:1 | 194% | N |
| | 2:1 | 154% | N |

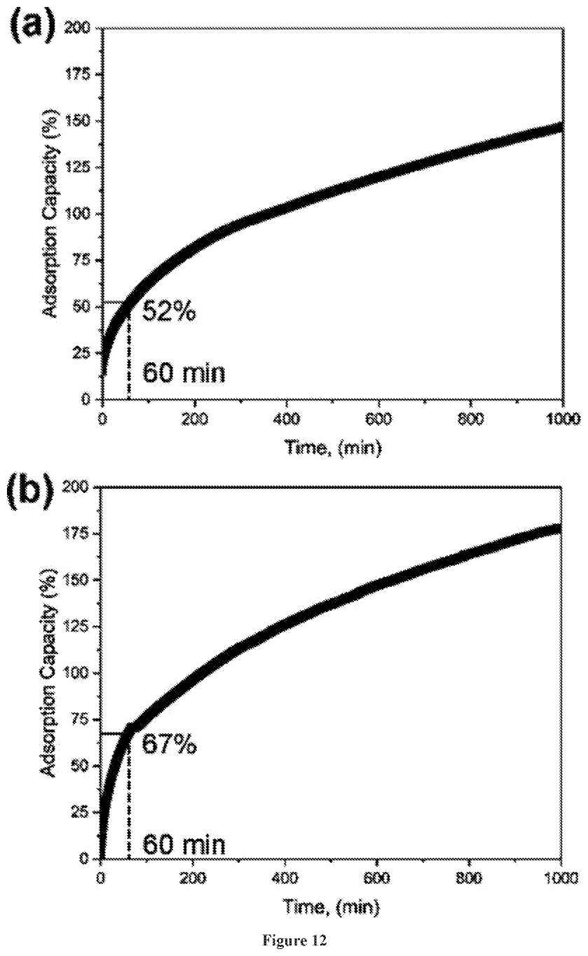

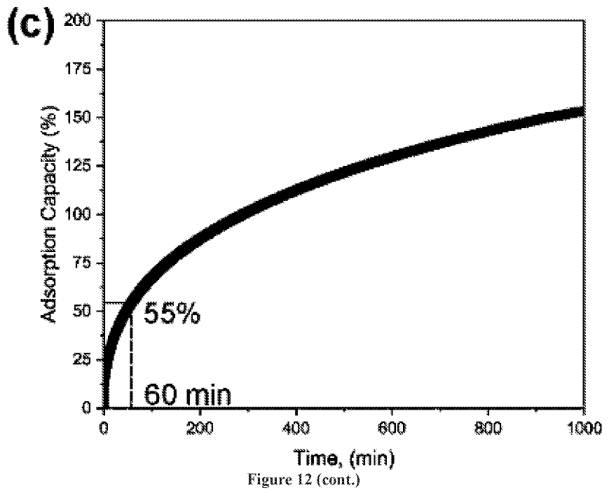

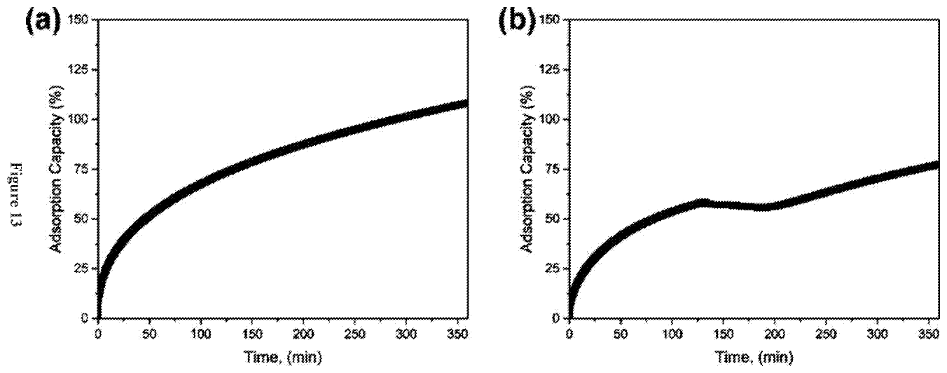

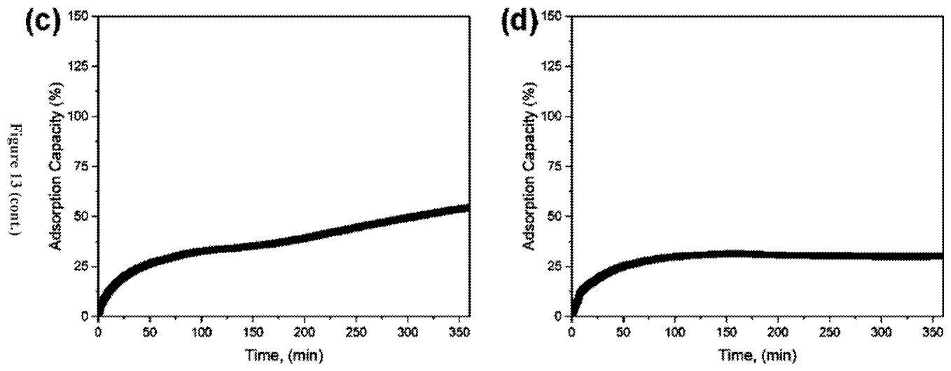

FIG. 12 shows the adsorption rate of GO-based aerogel with different concentrations of initial GO solutions and weight ratios of cross-linker, Ca²⁺. FIG. 12(a-b) shows the rate of GO-based aerogel with different concentrations of initial GO solution but with the same weight ratio of cross-linker. The aerogel with a higher concentration of GO showed a faster adsorption rate and capacity, presumably because of an increase of adsorption sites in the aerogel. In 60 min, the aerogel with 1 wt % initial concentration and 1:1 weight ratio of Ca²⁺ had an adsorption capacity of 52% whilst the aerogel with 1.5% initial concentration had a capacity of 67%. FIG. 12(c) shows that the adsorption rate and capacity of different GO-based aerogel can be adjusted by tuning the weight ratio of cross-linker to achieve a similar performance (c.f. FIG. 12(a)). The GO-based aerogel used in FIG. 12(c) was used in the following studies to enable comparison of the results.

### The Effect of Relative Humidity on the Capacity of Aerogel

The adsorption capacity of the optimized GO-based aerogel was measured under different relative humidity (RH). Table 5 shows that the adsorption capacity decreased from 1⁵⁴% to 31% when the RH was decreased from 100% to 50%. The lateral dimension of GO used here was <500 nm.

TABLE 5
Details of GO aerogels in water adsorption tests
with RH ranging from 50-100% without compression

| Concentration | | | | |
|---|---|---|---|---|
| of GO | | Weight of | Adsorption | |
| solution | GO:Ca²⁺ | aerogel, g | Capacity | RH |
| 1.5 wt % | 2:1 | 0.5643 | 154% | 100% |
| 1.5 wt % | 2:1 | 0.6639 | 56% | 80% |
| 1.5 wt % | 2:1 | 0.7063 | 40% | 70% |
| 1.5 wt % | 2:1 | 0.6586 | 31% | 50% |

Note:
the RH was controlled by the flow rate and temperature of moisture manually.

FIG. 13 shows the relationship between time and adsorption capacity of GO-based aerogels under different RH. Under high humidity, the adsorption capacity showed a continuous and rapid increase. Under low humidity, the GO-based aerogel had a low adsorption capacity. However, it still adsorbed rapidly at the beginning and reached its maximum adsorption capacity under the low RH. Comparing the adsorption performance of aerogels under different RH (FIG. 13(a-d)), the adsorption rate did not decrease significantly within 20 min from the beginning of each experiment.

### The Mutual Effect of Relative Humidity and Compression on the Capacity of Aerogel

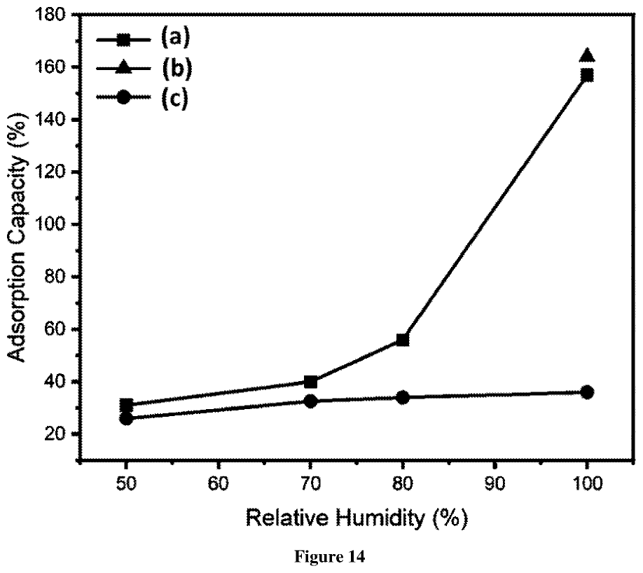

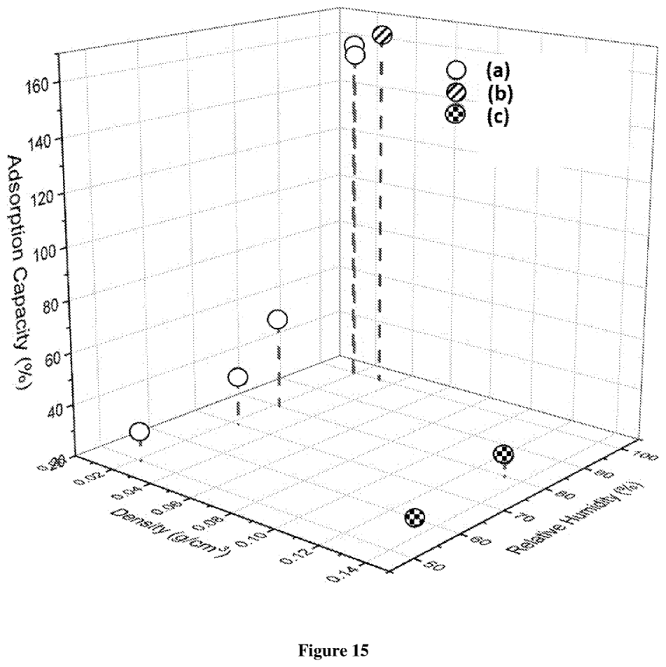

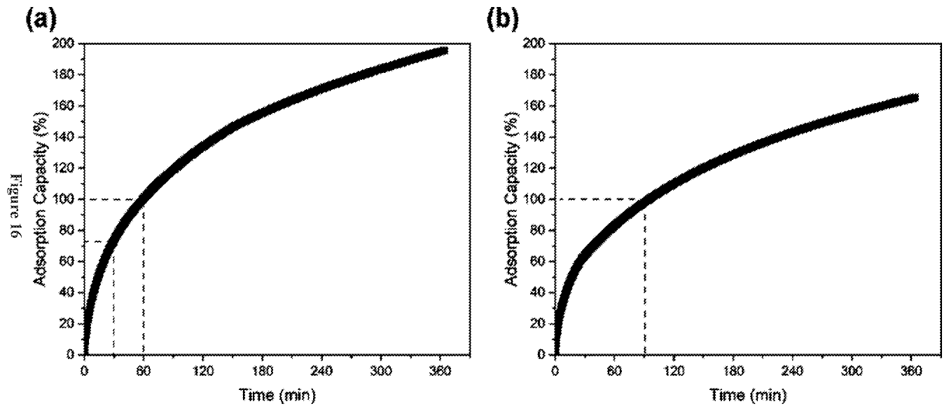

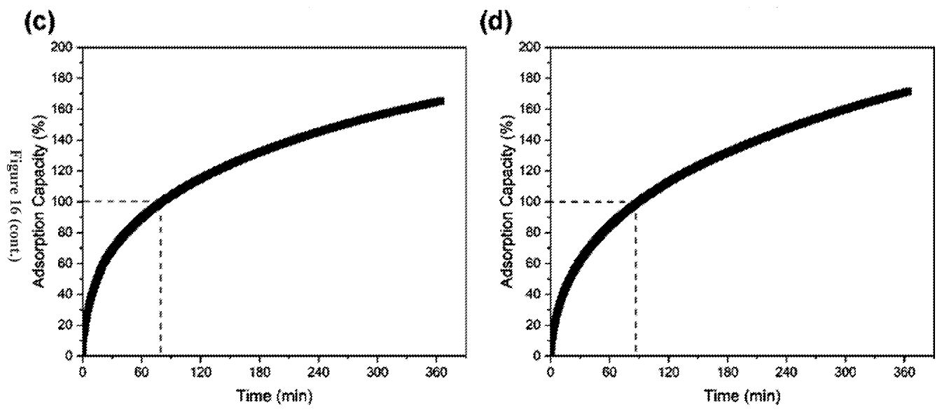

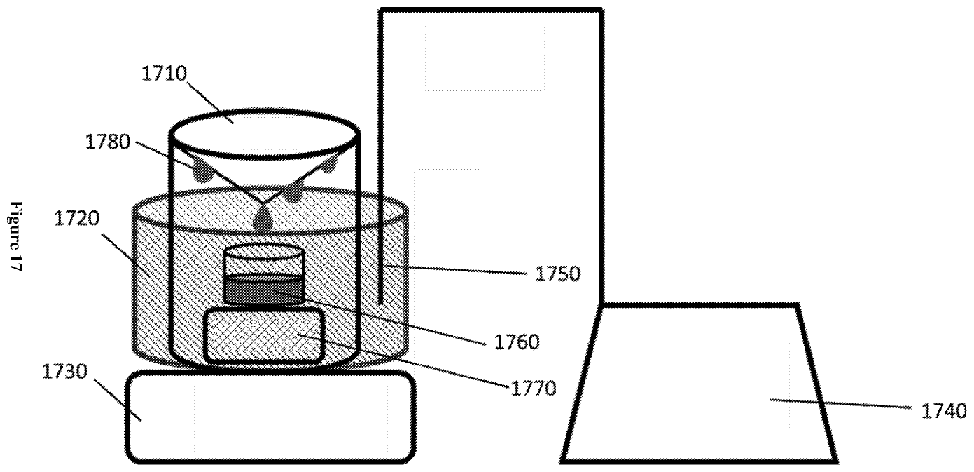

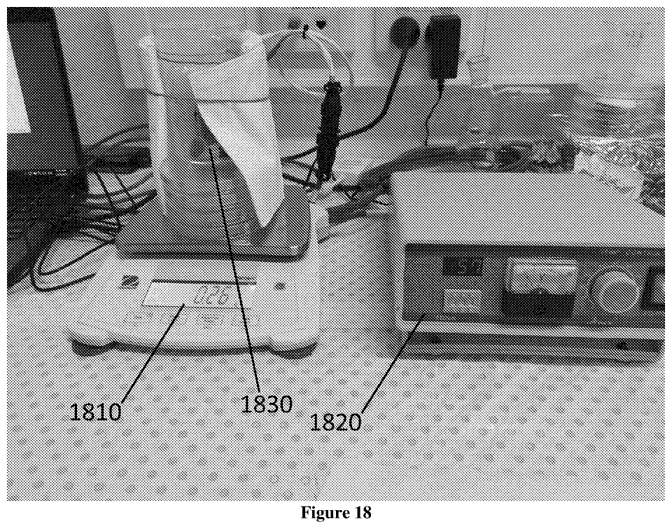

The adsorption capacity of GO-based aerogel was decreased as the relative humidity was decreased. However, as shown at FIG. 14, the adsorption capacity was significantly higher for the GO aerogel, even if reduced by 50% in volume as compared with silica gel. However, as shown in FIG. 15, the capacity decreased significantly when there was a 75% reduction in volume. The decrease in adsorption capacity of the aerogel may be because of the high pressure, which the inventor's postulate may have damaged the porous microstructure of the GO-based aerogel.

Table 6 shows the detailed results of adsorption capacity of GO-based aerogel under different compression and RH. The density of the aerogel was calculated in order to understand the effect of compression and RH on the aerogel adsorption properties.

TABLE 6
Details of GO aerogels in adsorption tests with
RH ranging from 50-100% with compression.

| Density, g/cm³ | Compression | Adsorption Capacity | RH |
|---|---|---|---|
| 0.0182 | N | 157% | 100% |
| 0.0324 | Y, 50% volume reduce | 164% | 100% |
| 0.0188 | N | 154% | 100% |
| 0.0221 | N | 56% | 80% |
| 0.0235 | N | 40% | 70% |
| 0.0220 | N | 31% | 50% |
| 0.1305 | Y, 75% volume reduce | 20% | 60% |
| 0.1323 | Y, 75% volume reduce | 28% | 80% |

Optimized Adsorption Capacity of eGO-Based Aerogel

A stable eGO-based aerogel with outstanding adsorption capacity was synthesized from eGO which was produced by an electrochemical method. The highest adsorption capacity was 310% at 100% relative humidity. Table 7 shows that the adsorption capacity of eGO aerogel did not significantly change after 4 cycles. The difference in the adsorption capacity was mainly caused by the initial weight of aerogel which can be significantly influenced by the drying process. FIG. 16 shows that the adsorption rate slightly decreased after the first adsorption measurement. In the first cycle, the adsorption capacity reached 100% within 60 min. After that, the adsorption rate of eGO-based aerogel remained relatively stable, reaching 100% adsorption capacity within around 90 min.

TABLE 7
The adsorption capacity of eGO-based aerogel after 4 cycles.

| Weight of aerogel, g | Cycle | Adsorption Capacity | RH |
|---|---|---|---|
| 0.2879 | 1 | 307% | 100% |
| 0.2929 | 2 | 240% | 100% |
| 0.2810 | 3 | 310% | 100% |
| 0.2995 | 4 | 254% | 100% |

### Desorption Process for Water Recycling

After the adsorption capacity test, the GO-based aerogel was saturated with water molecules. Then a desorption test was performed to release the water from the GO-based aerogel. This process included an evaporation step. The schematic illustration for the experimental setup is shown in FIG. 17. The saturated GO-based aerogel 1770 was sealed in a clean container with a conical top 1710. Ice was placed onto the top to enable condensation 1780 to form as the water was released from the aerogel. The container was covered with a heat mat 1720 and heated with heater 1730. A temperature controller 1740 and probe 1750 were used to accurately monitor and providing heat for the evaporation. Under heating conditions, the water was evaporated, condensed on the conical top and then collected in container 1760. After the collection of condensed water, the quality of the desorbed water was measured by inductively coupled plasma mass spectrometry (ICP-MS).

### Setup for Desorption Process

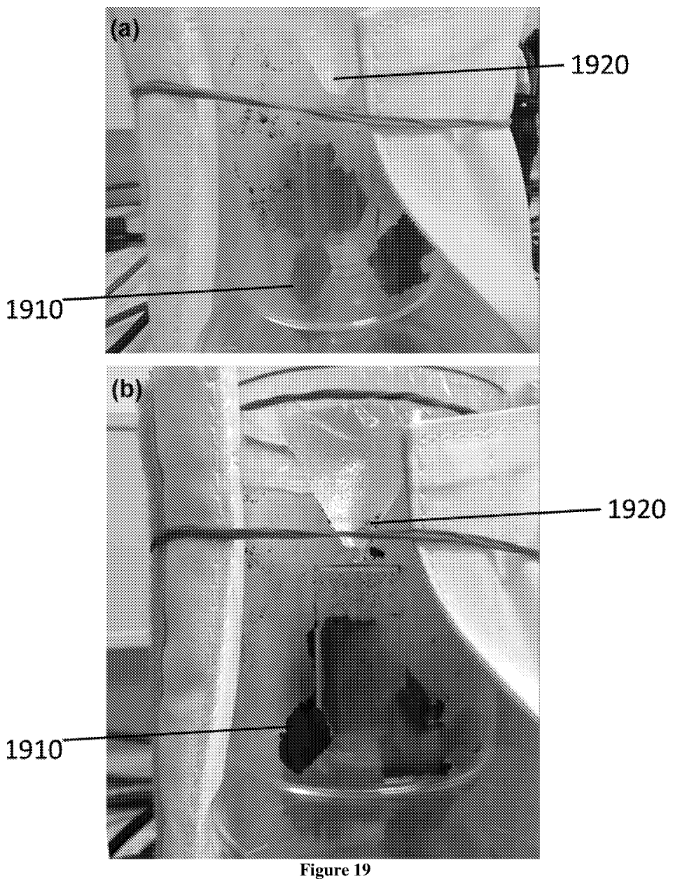

FIG. 18 shows the experimental setup of a laboratory scale desorption process. The temperature of the heat mat was controlled at 50° C. by the temperature controller 1820 in order to protect the GO-based aerogel from being reduced under high temperature. The balance 1810 was used to monitor the weight of water collected from the GO-based aerogel 1830. The efficiency of the desorption process was largely based on the temperature. FIG. 19(a) shows that during the heating process, the moisture from the aerogel 1910 was released, and then condensed on the cooled top 1920 (FIG. 19b). In this trial, 1.4 g water was collected out of 2.7 g adsorbed water from the GO-based aerogel at 50° C.

### Quality of Recycled Water

The quality of the recycled water from the GO-based aerogel was measure by ICP-MS. As the characterization of water quality is very sensitive, minor contamination can result in unreliable results. Especially for the water from the desorption process, there are many procedures involved from the preparation of aerogel to the final desorption test. The combination of these procedures can increase the possibility for contamination of the desorbed water. Table 8 shows the analysis results of the recycled water from the desorption process. Two measurements of recycled water were performed. The results show that there was a large amount of the contamination in recycled sample water-01, thought by the inventors to be due to improper cleaning of the container used in the desorption process. After proper cleaning of the containers (sample water-02), the contaminants, especially Ca, K, Zn and I decreased significantly. Although the concentration of some common elements in recycled water-02, such as Mg and Na, were still higher than that of tap water, they were significantly decreased compared with that of recycled water-01. It indicates that the contaminants can be effectively decreased by proper cleaning of the components used for the process. However, the inventors postulate that a major issue causing the contamination may be the use of an oil pump for the freeze-drying step used for the preparation of the aerogels. The vapor of the oil could be a source of contaminants because the concentration of some elements that were otherwise not used for the production of the GO-based aerogels were abnormally high as shown in Table 8 (elements Al, B, Ba, Cu, Mg, Na, and Si). This problem can be overcome by changing the pump system to, e.g., an oil-free pumping system.

TABLE 8
The analysis of water regenerated from the desorption process.

| | Recycled water-01 | Recycled water-02 | Tap water |
|---|---|---|---|
| Element | μg/L | μg/L | μg/L |
| Al | 37.76 | 163.5 | 11.93 |
| B | 53.4 | 165 | 15.0 |
| Ba | 39.3 | 94.6 | 1.1 |
| Ca | 30287.4 | 0.00 | 20 |
| Cd | 0 | 0.00 | 0.36 |
| Ce | 0.86 | 0.06 | 0.00 |
| Co | 0.71 | 0.19 | 0.12 |
| Cr | 0 | 0.00 | 0.29 |
| Cu | 518.06 | 166 | 90.78 |
| Dy | 0.11 | 0.01 | 0.08 |
| Er | 0.06 | 0.00 | 0.08 |
| Eu | 0.04 | 0.01 | 0.04 |
| Fe | 0 | 0.0 | 0.0 |
| Ga | 0 | 0.07 | 0.00 |
| Gd | 0.11 | 0.01 | 0.08 |
| Hf | 0.07 | 0.66 | 0.17 |
| Hg | 0 | 0.00 | 0.61 |
| Ho | 0.02 | 0.00 | 0.03 |
| I | 43.08 | 3.08 | 4.29 |
| K | 8225 | 162 | 274 |
| La | 0.71 | 0.03 | 0.03 |
| Mg | 3835 | 74.6 | 17 |
| Mn | 9 | 0.5 | 1.5 |
| Na | 52539 | 510 | 287 |
| Nb | 0 | 1.66 | 0.00 |
| Nd | 0.69 | 0.02 | 0.12 |
| Ni | 1.61 | 0.36 | 3.97 |
| Os | 0 | 0.00 | 0.10 |
| P | 4.8 | 0.0 | 35 |
| Pb | 7 | 1.6 | 7.2 |
| Pd | 0.01 | 0.00 | 0.00 |
| Pr | 0.17 | 0.01 | 0.03 |
| Pt | 0 | 0.0 | 0.2 |
| Rb | 8.22 | 0.62 | 0.18 |
| Re | 0 | 0.01 | 0.06 |
| Sb | 0 | 0.07 | 0.13 |
| Sc | 0.56 | 0.06 | 0.03 |
| Si | 1115 | 1117 | 156 |
| Sm | 0.11 | 0.00 | 0.07 |
| Sn | 0 | 9.4 | 1.2 |
| Sr | 94.46 | 1.60 | 0.21 |
| Ta | 0 | 1.26 | 0.00 |
| Te | 0 | 2.7 | 0.0 |
| Th | 0.2 | 0.0 | 0.4 |
| Ti | 21.57 | 0.00 | 0.00 |
| Tl | 0.06 | 0.01 | 0.05 |
| U | 0 | 0.52 | 0.18 |
| V | 0.93 | 0.00 | 1.17 |
| W | 0 | 2.26 | 0.00 |
| Y | 0.59 | 0.02 | 0.00 |
| Yb | 0.05 | 0.00 | 0.09 |
| Zn | 756 | 20.8 | 185 |
| Zr | 0 | 0.34 | 0.00 |

Note:
The elements Ca, I, K, and Zn showed a significant decrease after cleaning, and the concentrations were even lower than that of tap water. The elements Al, B, Ba, Cu, Mg, Na, and Si still had a high concentration after cleaning as compared with tap water. However, some elements that were not used in the process of GO-based aerogel may have been introduced to the aerogel due to contamination from the oil pump used for the experiments.

### Prototype of Atmospheric Water Generator

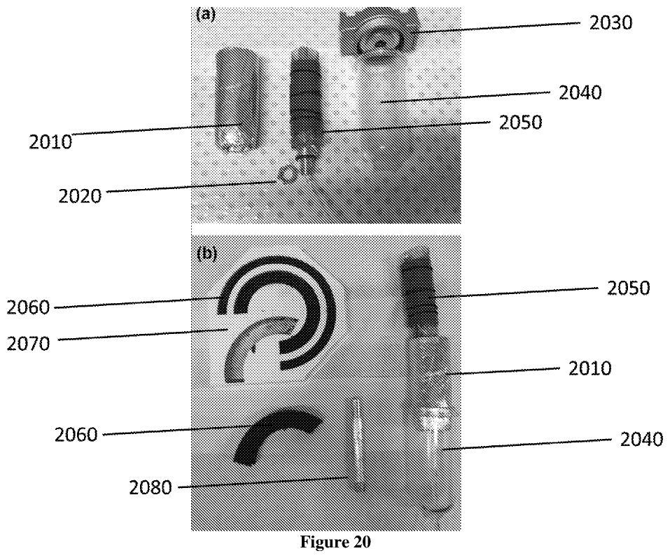

A prototype atmospheric water generator using the aerogel was made. FIG. 20 shows the components of the prototype and the GO-based aerogel mould to fit the prototype. The GO-based aerogel 2060 can be sealed in a canister with a moisture inlet and outlet.

The prototype of the atmospheric water generator comprises a canister as shown in FIG. 20. This canister is divided into four parts: an outer shell 2040, lid 2030, thermal insulation layer 2010, and core layer 2050. The thermal insulation layer 2010 consists of fiberglass and aluminium foil. The insulation layer is effective when the temperature is below 80° C. The core layer 2050 includes a heat mat, temperature sensor and stainless-steel mesh bag. The aerogel 2060 formed using mould 2060 is first cut into small pieces and put into the stainless-steel mesh bag.

In certain embodiments, the canister as described above may be connected to an inlet valve, an outlet valve, and a collection valve. In use in an “adsorption configuration”, the collection valve is closed, and the inlet and outlet valves are opened, such that a moisture containing gas may be passed into the canister via the inlet valve and exposed to the aerogel, before exiting the canister as a dried gas via the outlet valve. After a period of time during which the aerogel will have adsorbed an amount of water from the gas, the inlet and outlet valves are closed, and the collection valve is opened in a “collection configuration”, at which time the heat mat is used to heat the aerogel to discharge the water via the collection valve into a water collection container. Once all of the water has been discharged, the collection valve is closed and the inlet and outlet valves are opened so that the system is back in the “adsorption configuration”, thereby enabling further water to be adsorbed by the aerogel. This process may be repeated a number of times to increase the amount of water collected by the atmospheric water generator.

The assembly and disassembly procedures for the prototype are set out below.

### Assembly Procedure

1. The thermal insulation layer 2010 is pushed back into the outer shell 2040 carefully and slowly. The layer is held with uniform force.

2. The cable of the heat mat and thermal sensor is passed though the insulation layer 2010 and outer shell 2040.

3. The core layer 2050 is pushed back into outer shell 2040. The aluminium tube and the mesh bag should be pushed at the same time carefully and slowly. The force on the stainless-steel mesh bag should be uniform.

4. The nut 2020 on the bottom of core layer 2050 is assembled to further pull down the core layer into shell. The outer shell lid 2030 is assembled.

### Disassembly Procedure

1. The outer shell lid 2030 is removed. The nut on the bottom of core layer is removed.

2. The aluminium tube 2080 in the centre of core layer is carefully pushed out. At the same time, the stainless-steel mesh bag is pulled out by needle nose pliers.

3. The cable of the heat mat and the thermal sensor is removed.

4. The thermal insulation layer can be pulled out rapidly and easily using needle nose pliers.

### 3D-Printed Mould Module for GO-Based Aerogel Preparation

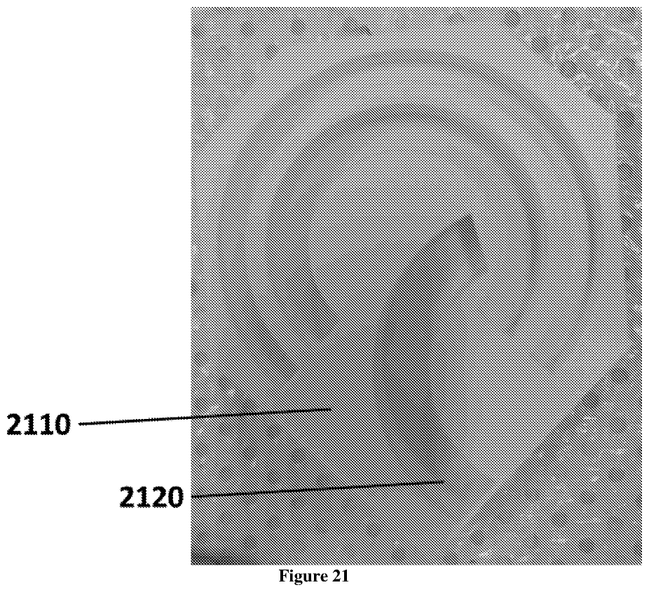

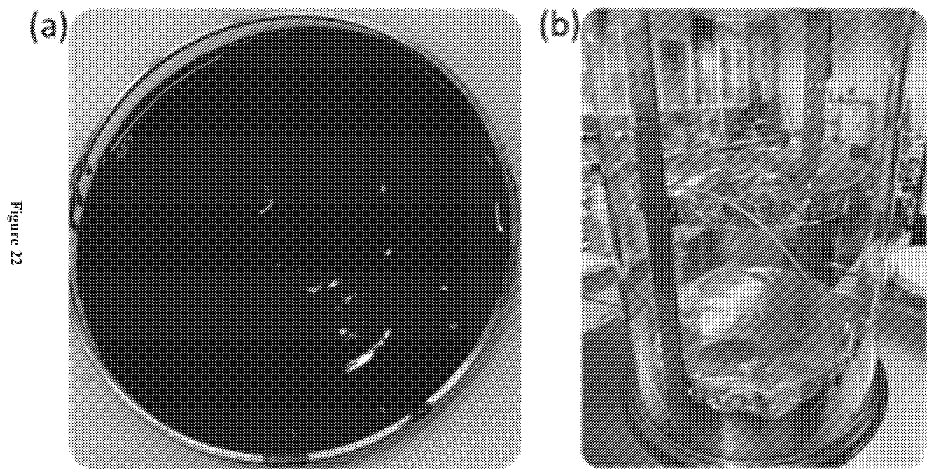

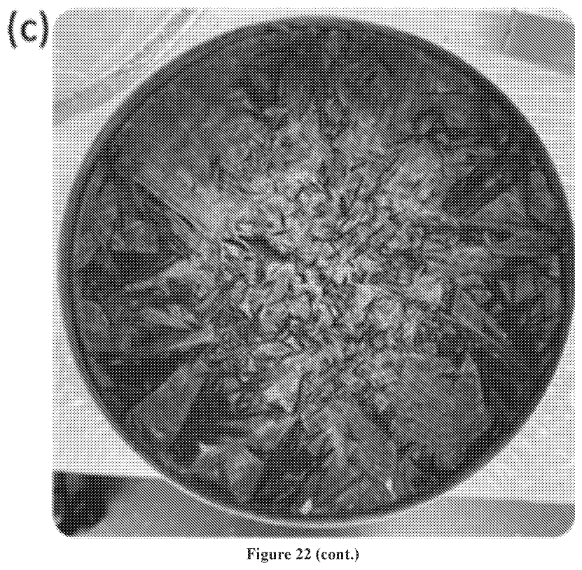

The mould module for GO-based aerogel preparation enables fabrication of the aerogel for incorporation into the canister. The shape of the module for aerogel is largely depended on the internal structure of the canister. FIG. 21 shows a module designed for a GO aerogel for inserting into the canister as shown in FIG. 20.

### Preparation of Graphene Oxide Aerogel

Graphene oxide aerogel was produced by mixing GO and ionic crosslinker at different weight ratios. The detailed procedure for making aerogel at 1:1 GO:Ca²⁺ is as follows: first, stock solution of cationic crosslinker (calcium chloride, CaCl₂)) was prepared by dissolving 20 g of CaCl₂) in 100 mL Milli-Q water at the concentration of 0.2 g/mL. Then 7.5 mL (1.5 g) of CaCl₂) was added to the 100 mL of GO suspension (1.5 g, 1.5 wt %), followed by well-mixing with the portable mixer for 15 to 20 min. The obtained mixture was then added to the appropriate petri-dish/metal tray for subsequent freeze-drying. All adsorption experiments of GO-aerogel were performed in the glove bag with controlled relative humidity (RH). FIG. 22 illustrates the step-by-step preparation of GO-aerogel. The mass of small scale aerogel was approximately 1 to 2 g.

### Influence of GO Flake Size on the Adsorption Performance of Aerogel

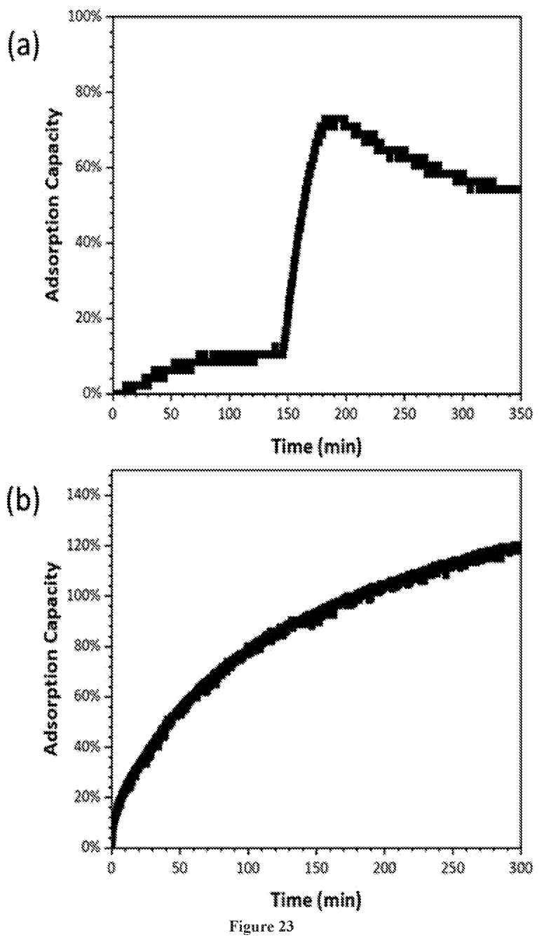

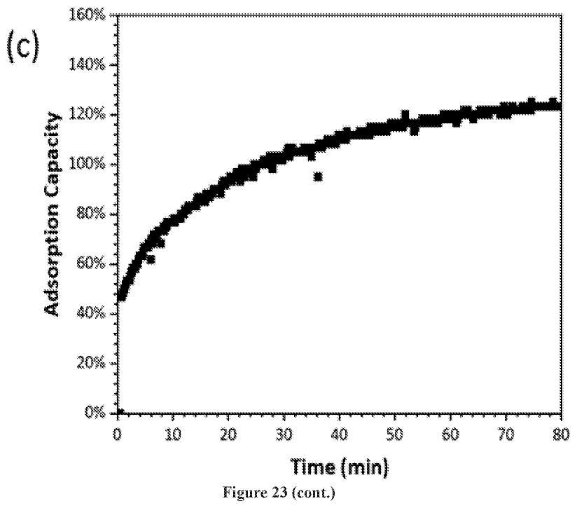

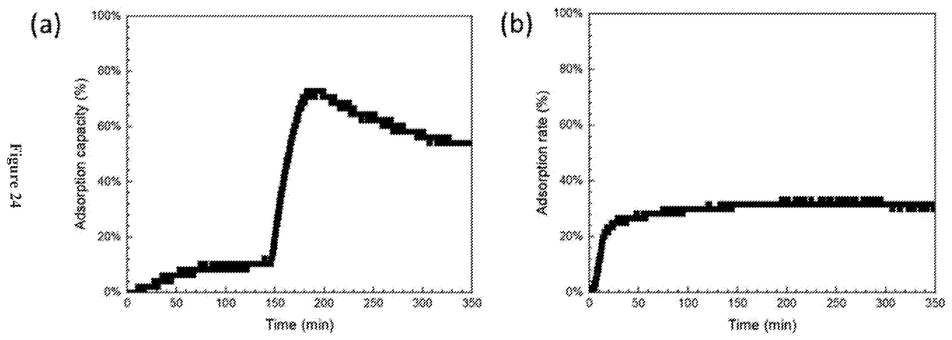

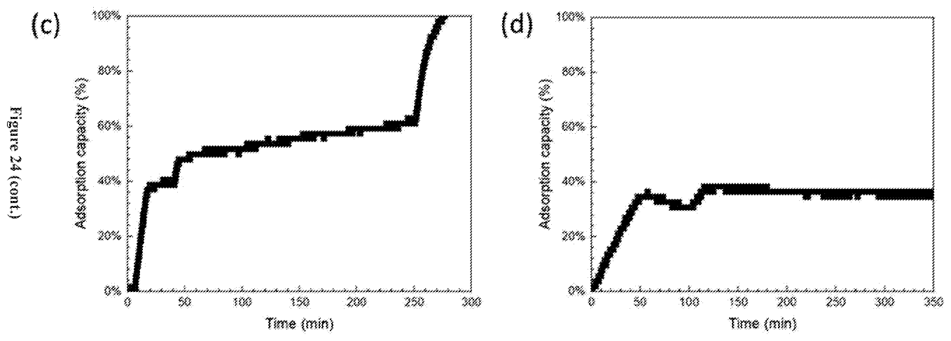

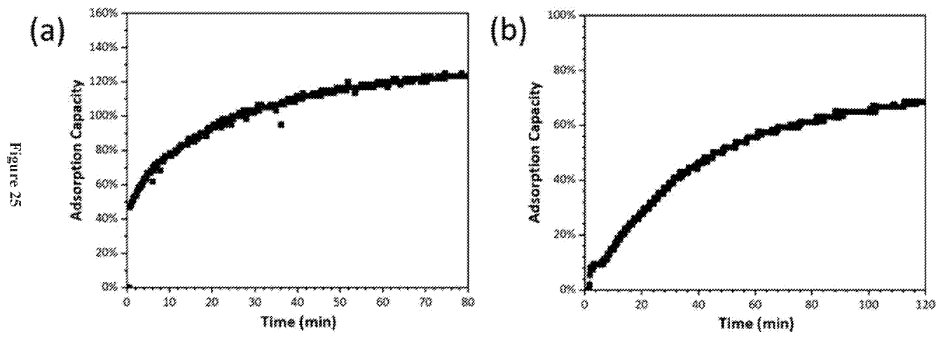

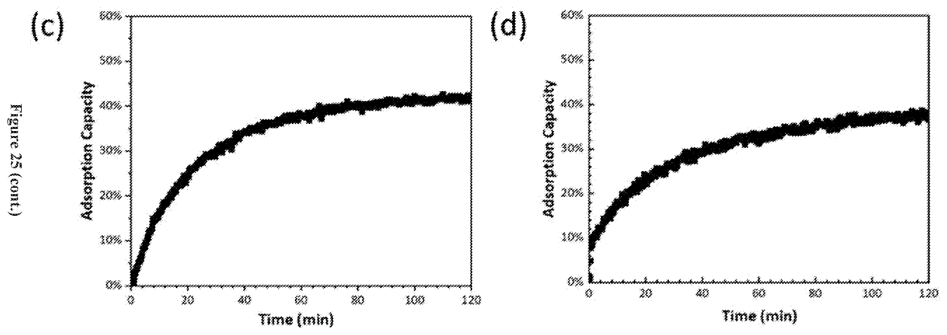

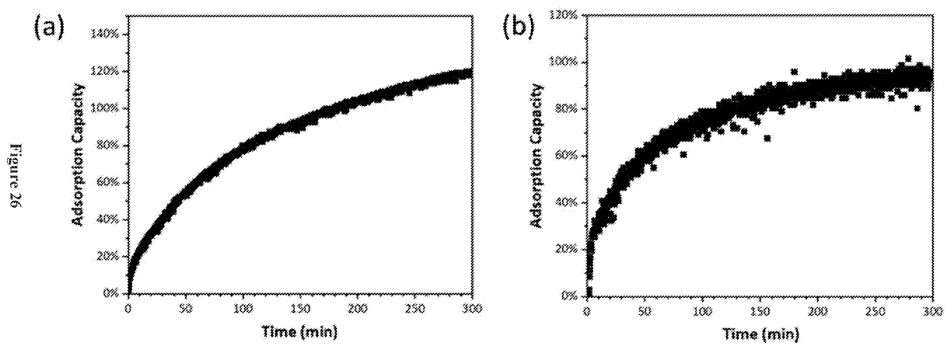

The flake size of graphene oxide may have an influence on the adsorption performance of aerogel as a consequence of varying porosities. Hence, a water uptake study was undertaken by using aerogel samples prepared by GO with different lateral dimensions: ˜300 nm, ˜1 μm, and ˜5 μm. The aerogels were prepared by using Ca²⁺ crosslinker at 1:1 ratio with GO. The adsorption experiments were carried out in a glove bag with controlled humidity 80-90%. According to the results shown in FIG. 23, the adsorption capacity increased with decreasing the GO flake size driven by higher porous structure of aerogel.

### Influence of the Mixture of GO Flake Sizes on Adsorption Performance of Aerogel

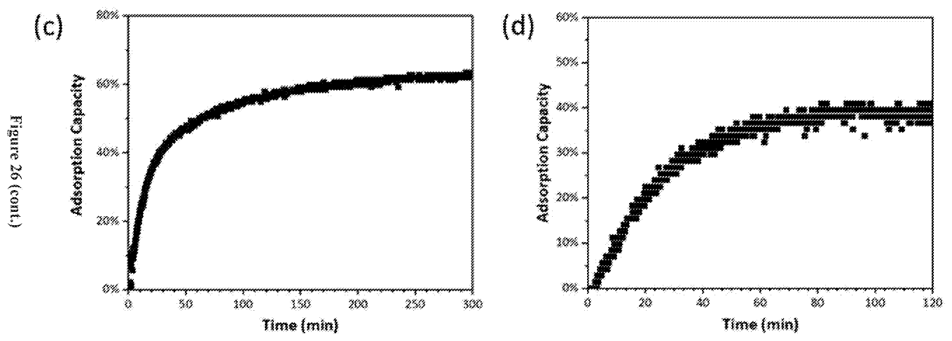

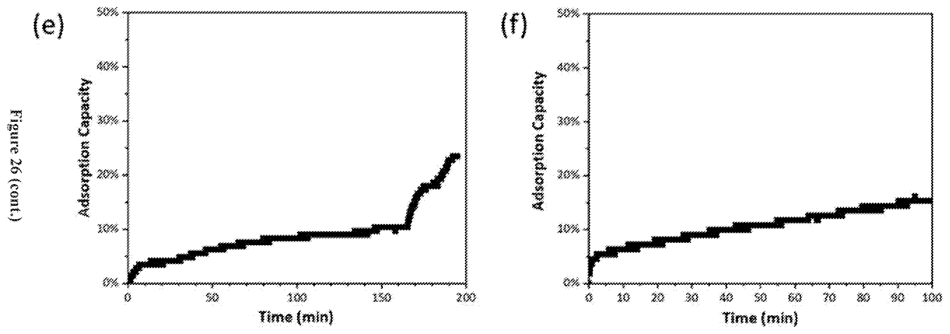

The GO aerogel (prepared by crosslinking with Ca²⁺ at 1:1 weight ratio) with a flake size of approximately ˜5 μm exhibited an adsorption performance of around 73% within 6 hrs under 80% humidity. This adsorption rate may be lower than that of aerogel with smaller GO counterparts due to the less porous structure induced by larger flakes. Considering this, a series of experiments were undertaken to better understand the influence of flake size on the performance of aerogel. This was done by incorporating the above-mentioned GO flakes with smaller laminates ˜300 nm in increasing ratios, i.e. 100:0, 75:25, 50:50, and 25:75. As depicted in FIG. 24, significant changes were observed, and the aerogel with the equal ratio of two different flake sizes gave rise to the highest performance of ˜100%.

### Adsorption Performance of Aerogel at Different Humidity

Considering the application of GO aerogel for water generation at different humid environments, a set of experiments on water uptake was performed at varying humidity. Two separate experiments were undertaken for aerogels using GO laminates with two different sizes: ˜300 nm and ˜1 μm, respectively.

### Aerogel Prepared by Using Small GO Laminates (˜ 300 nm)

Adsorption tests using smaller laminates ˜300 nm were performed under different humidity: 90%, 75%, 60%, and 50%. All aerogel samples were prepared by using a Ca²⁺ crosslinker (1:1 weight ratio). It was observed that relative humidity can play an important role in the adsorption performance of the aerogels. The adsorption capacity reached 125% at 9% humidity, then decreased at lower relative humidity (FIG. 25). The preferable performance above 35% was still achieved even under 50% humid conditions.

### Aerogel Prepared by Using Larger GO Laminates (˜1 μm)

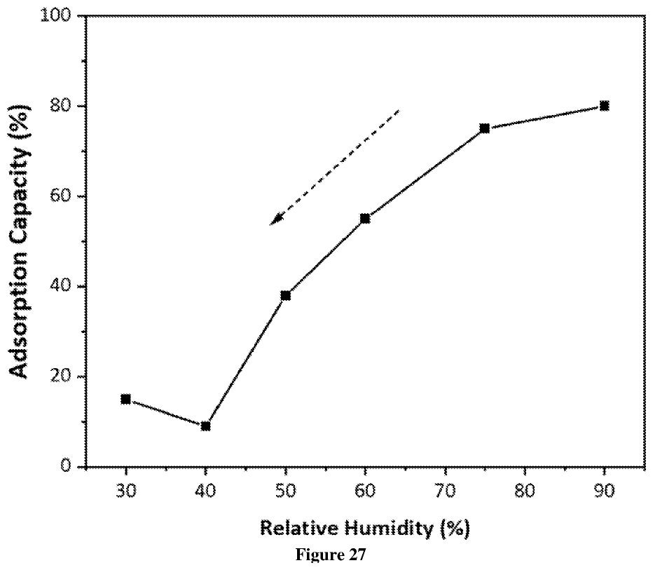

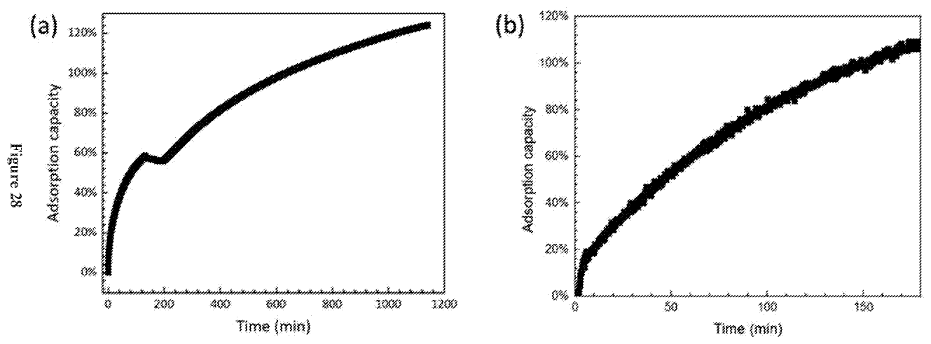

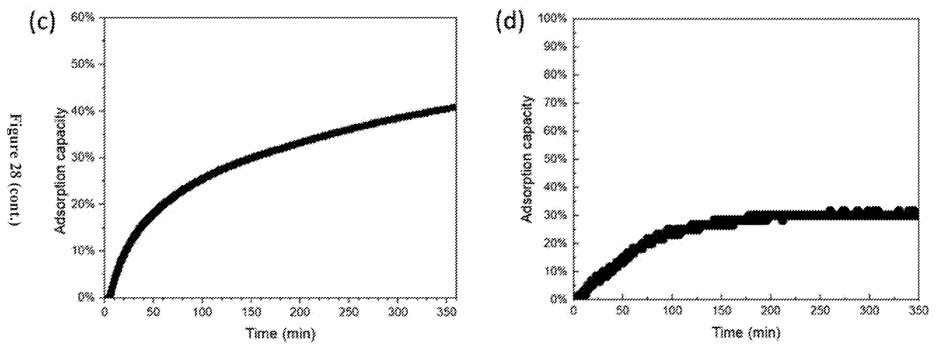

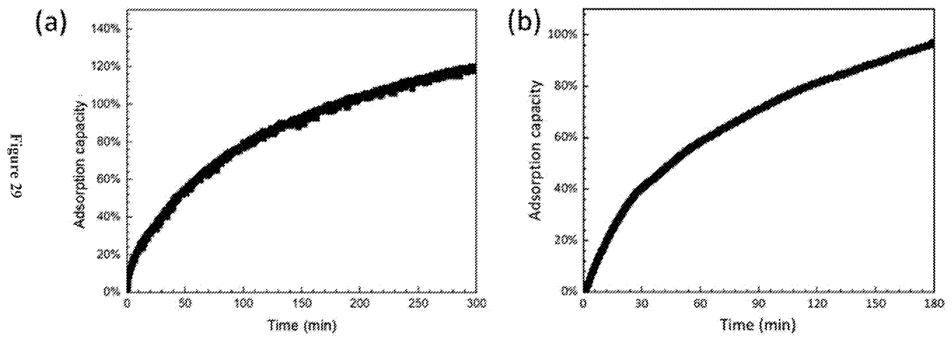

The same experiment was repeated by using different batch of GO-aerogel also prepared by crosslinking with Ca²⁺ in a 1:1 weight ratio. The experiments were undertaken for 5 hrs under a range of relative humidity: 90%, 75%, 60%, 50%, 40%, and 30%. Similar to the above-mentioned experiment, the relatively higher adsorption capacity above 35% was obtained at 50% humidity. Moreover, within 3 hrs, it was found that an adsorption capacity of around 15% was obtained at 30% of relative humidity as shown in FIG. 26. FIG. 27 presents a better visualization of the relationship between relative humidity and adsorption performance of the example GO aerogel.

### Adsorption Performance of Aerogel Prepared by Using Different Cationic Crosslinkers

A set of aerogel samples were prepared using different cationic crosslinkers: Ca²⁺, K⁺, Mg²⁺ and Al³⁺. The weight ratio between GO and crosslinker was maintained at 2:1, and the humidity was in the range of 75 and 90%. It was observed that the highest adsorption capacity up to ˜124% was achieved by using Ca²⁺ crosslinker, followed by ˜107.9% by using Al³⁺ (FIG. 28). Other Crosslinkers Mg²⁺ and K⁺ provided a highest capacity of around 42% and 30% respectively. As described above, adsorption experiments were performed in a glove bag with controlled relative humidity.

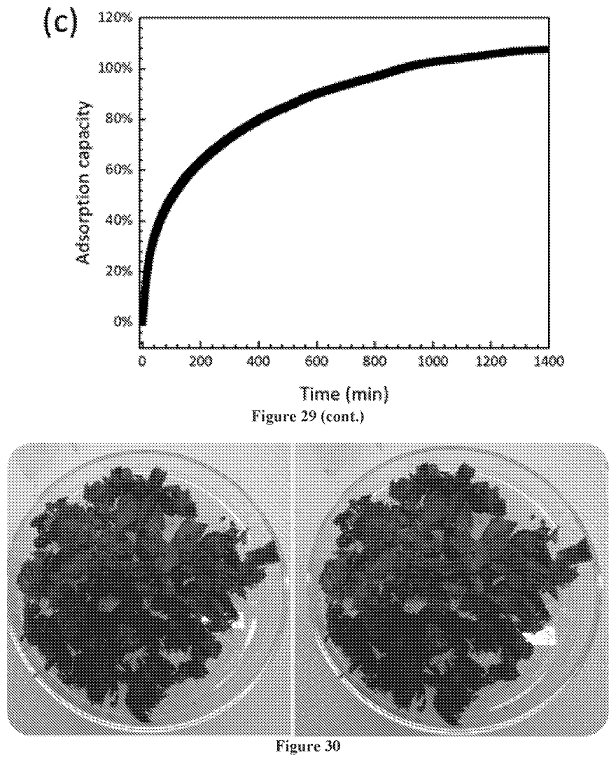

In addition, cations like Li⁺ and Fe³⁺ were also considered as comparisons with calcium crosslinkers. Here, the experimental set-up involved the preparation of aerogel in 1:1 wt ratio of GO and crosslinker (calcium chloride, lithium chloride, or iron (III) chloride) and the adsorption tests were carried out at a relative humidity of around 85-95%. Similar to previous experiment, aerogel prepared by using Ca²⁺ gave rise to above ˜120% adsorption capacity, while that prepared by using Li⁺ and Fe³⁺ induced ˜96% and ˜72.5% of highest capacity within a set time frame (FIG. 29). These findings showed that the aerogel expressed the highest performance when crosslinked with calcium ions.

### Adsorption Performance of Aerogels Having Different Shapes

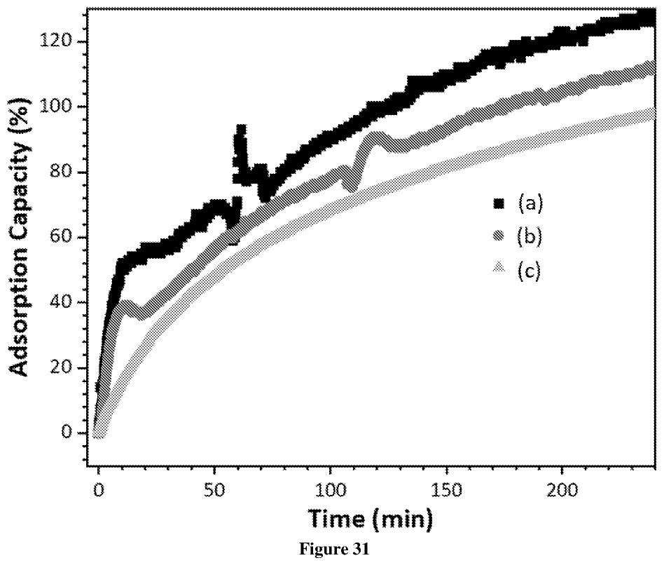

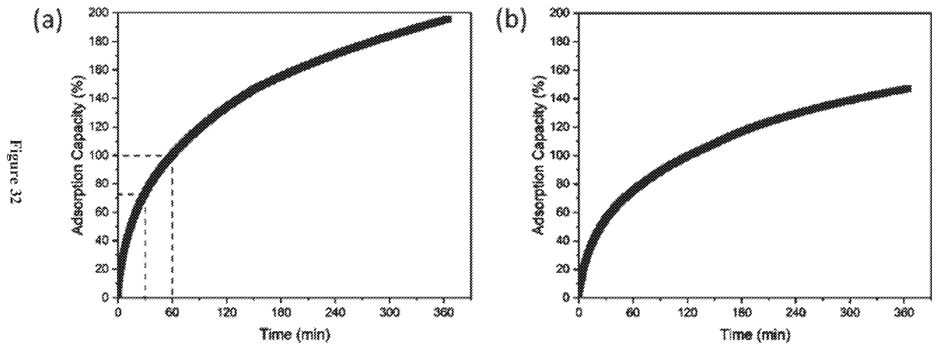

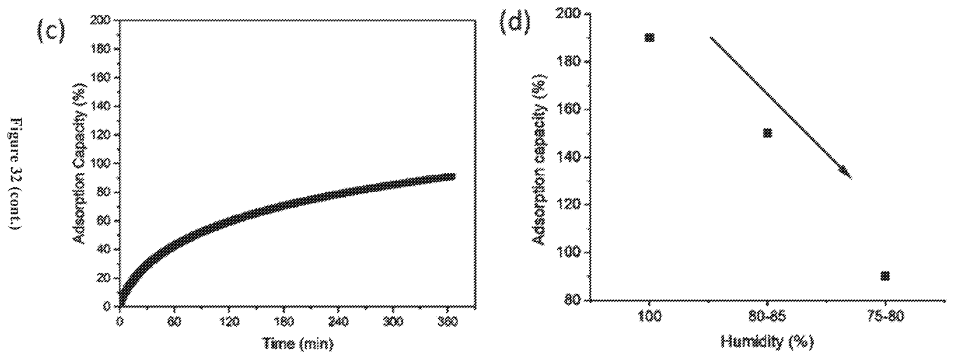

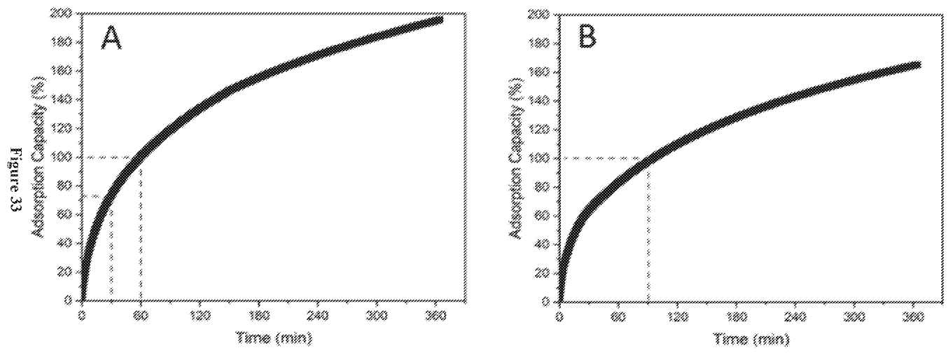

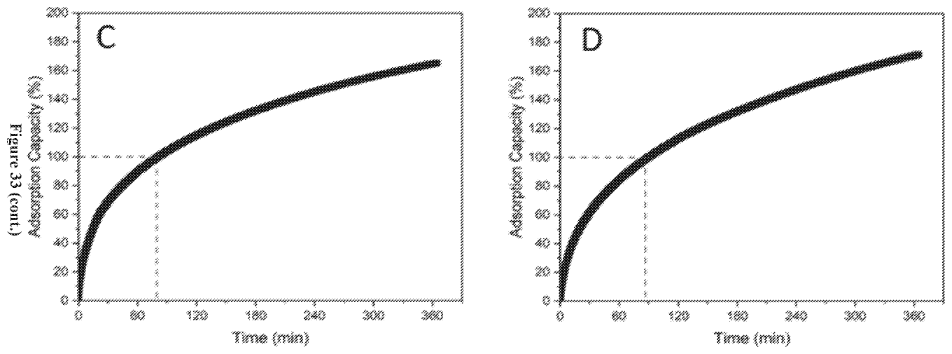

The water uptake of GO-aerogels in cake, flake (˜2 cm diameter) and powder forms was determined. First, three aerogel samples were prepared using a Ca²⁺ crosslinker (1:1 wt ratio), followed by freeze-drying. Aerogel in flake form was generated by scissor-cutting the freshly prepared aerogel. After cutting, the aerogel flakes were obtained with ˜2 cm diameter (FIG. 30). Then the aerogel in powder form was generated by grinding one aerogel cake using a Breville coffee and spice grinder. The water uptake studies of three aerogel samples were then performed at 90% humidity. As shown in FIG. 31, the highest adsorption capacity up to ˜127% was obtained by the aerogel cake, whereas ˜111% and ˜98% were achieved by aerogel in powder and flake forms, respectively.

Adsorption Performance of eGO-Aerogels

### Adsorption Performance of eGO at Different Humidity

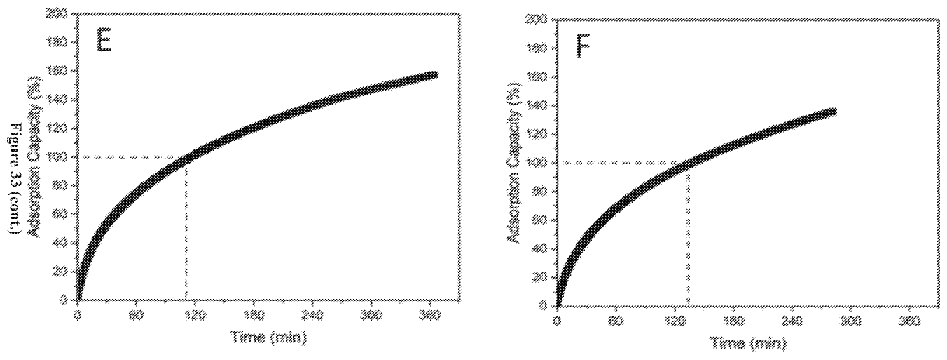

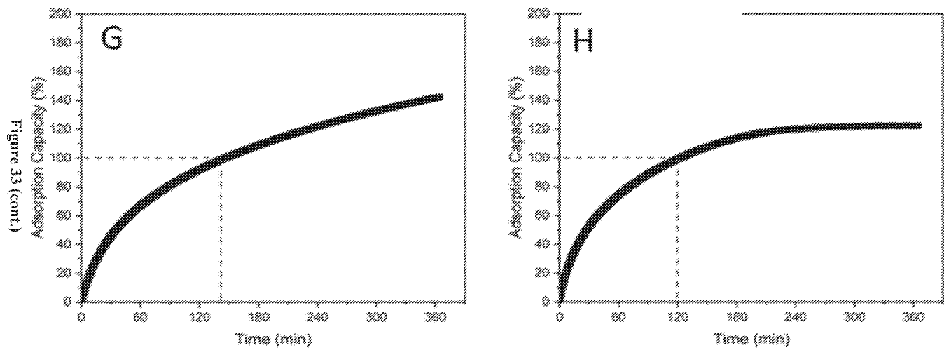

A eGO aerogel sample was prepared using a Ca²⁺ crosslinker at the 1:1 eGO:Ca²⁺. Then a performance test was undertaken inside a glove bag at different humidity: 100%, 80-85%, and 75-80%, respectively, for 6 hrs. The same trend was observed as for standard GO, i.e., the humidity decreased from ˜190% to ˜150% and ˜90% under conditions of lower humidity as shown in FIG. 32.

### Performance of eGO at Multiple Cycles of Adsorption

As reusability is an important property, the adsorption of eGO aerogel was performed over multiple cycles. A sample was first prepared by crosslinking GO with Ca²⁺ at a 1:1 weight ratio, and eight cycles of adsorption were performed at 100% humidity for 5-6 hr. The water adsorption capacity of aerogel in each cycle is presented in FIG. 33, which reveals a slight decrease in water uptake after each cycle. However, the aerogel maintained desirable performance with a highest capacity above 120% even after eight cycles, indicating the potential of eGO aerogel as a carbon-based desiccant for industrial applications.

### Adsorption Performance of eGO Made in Armidale

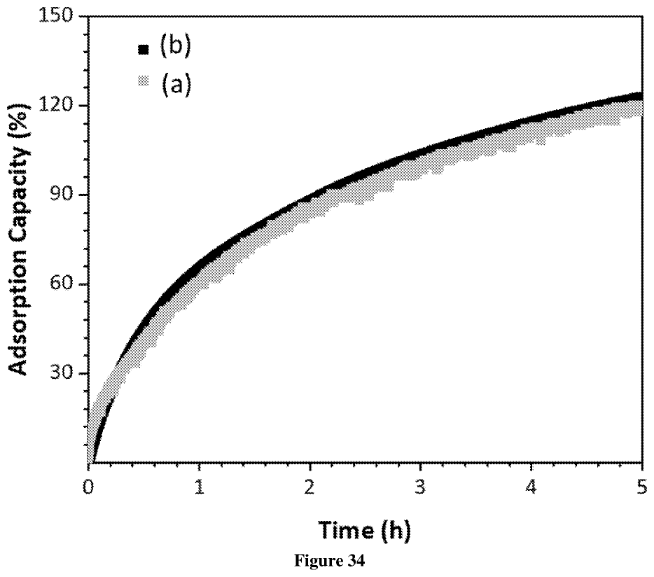

The adsorption performance of eGO aerogel (made in Armidale) crosslinked with eGO:Ca²⁺ in a 1:1 wt ratio was undertaken at 85-95% humidity. It was observed that the adsorption rate reached 122% within 5 hrs, which is similar to other eGO, samples as shown in FIG. 34.

Adsorption Performance of eGO-UNE

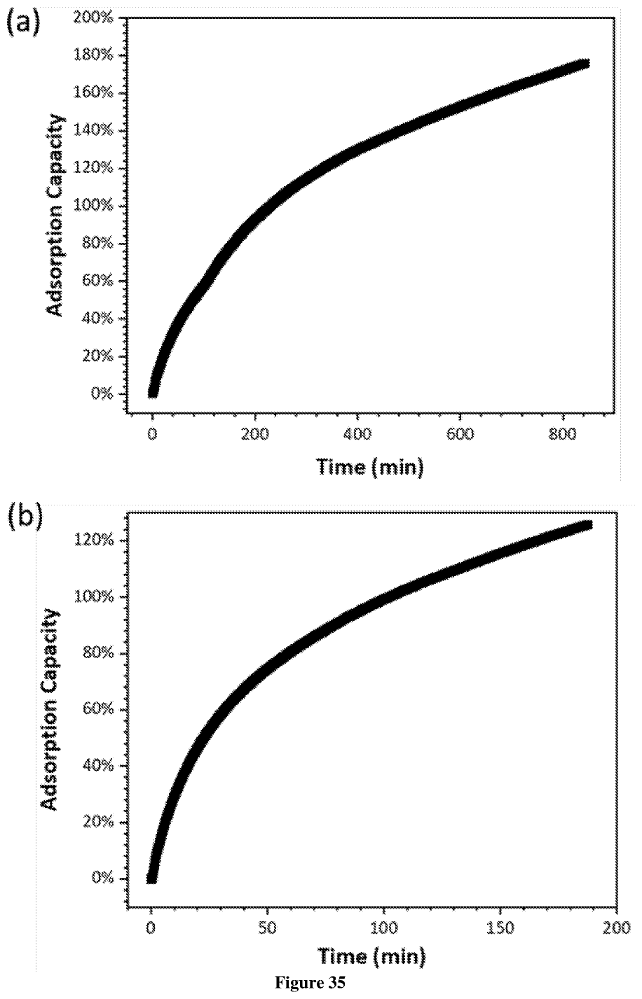

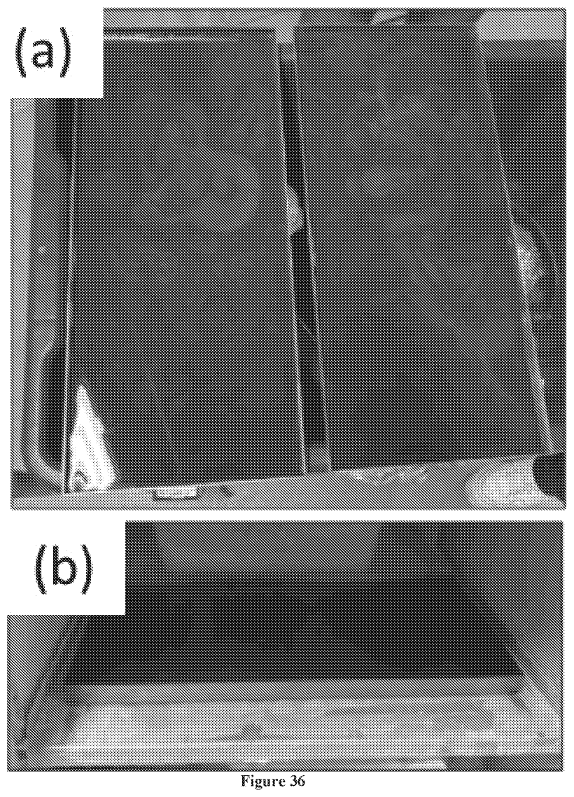

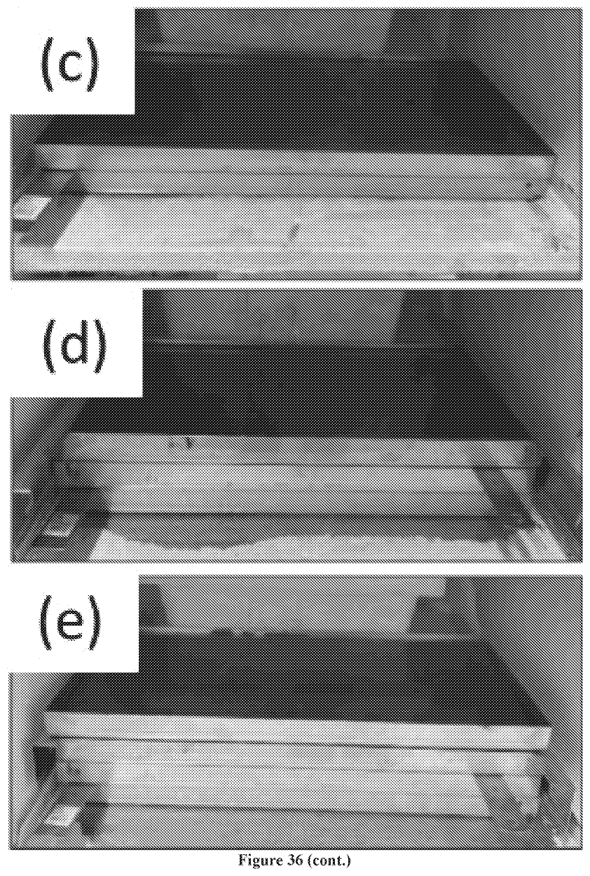

Two eGO aerogel samples prepared by crosslinking with Ca²⁺ at a weight ratio of 1:1 were tested. A water uptake study was undertaken inside a glove bag with controlled humidity at 90-95%. The highest capacities of sample 1 and sample 2 were approximately 177% and 125%, respectively as shown in FIG. 35.

### Adsorption Performance of GO-Aerogel on Large Scale

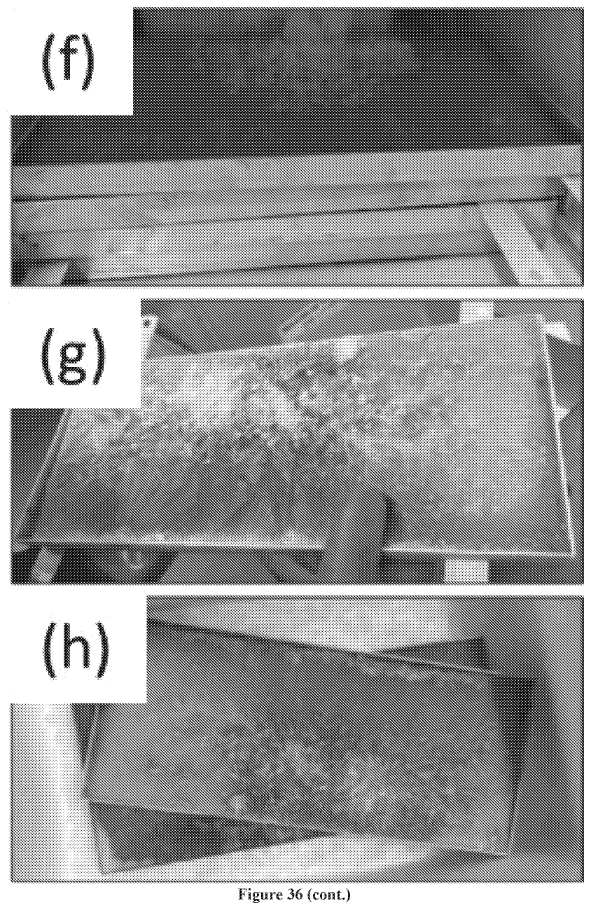

The performance of GO aerogel produced on a large scale was determined. The sample preparation was as follows: 40 g GO was crosslinked with Ca²⁺ at 1:1 wt ratio, then the suspension was stirred for 15-20 min, followed by separating into four metal trays (19 cm×35 cm×3 cm) and freezing in a −80° C. freezer (FIG. 36). After that, the frozen samples were freeze-dried at Scitek Company. FIG. 36 illustrates the preparation and freezing conditions of the large-scale GO suspension.

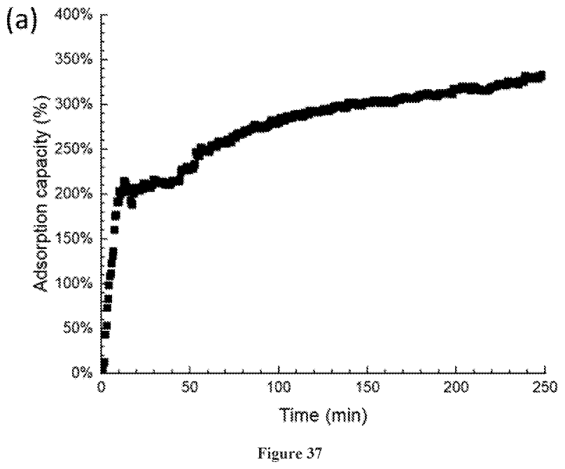

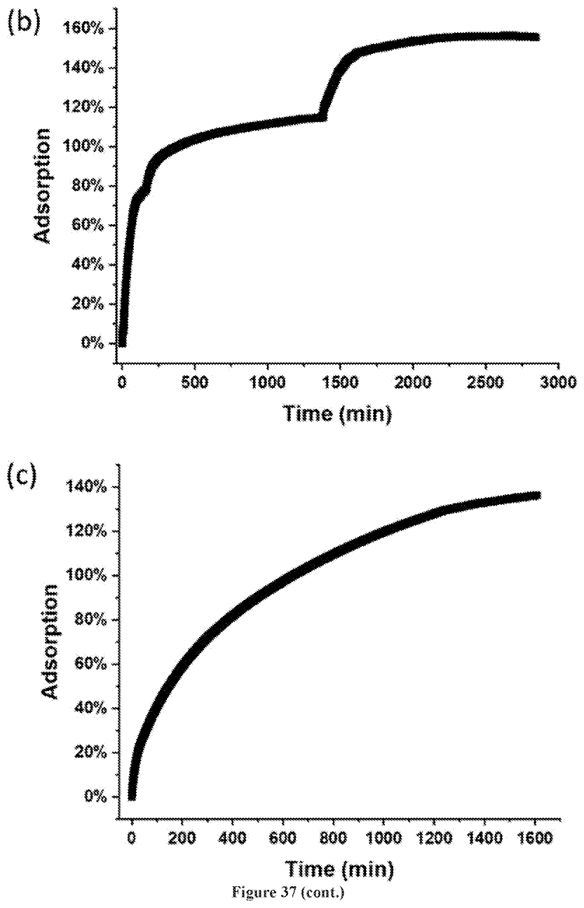

The 40 g aerogel samples were prepared three times, and are referred to as: 1^{st}2^{nd} and 3^{rd} batch aerogel, respectively. Approximately 11 g of 1^{st} batch aerogel was submitted to a water uptake study in a humidity chamber with around 90% relative humidity. It was observed that above 300% of water uptake was obtained within 4 hr as shown in FIG. 37a. The other two aerogels were tested in a glove bag with controlled humidity (85-95%). The sample was thoroughly dried under nitrogen before the performance test. The highest capacity ˜160% was obtained for ˜8.22 g of 2^{nd} batch aerogel (FIG. 37b). The third batch aerogel (˜10.12 g) gave rise to an adsorption capacity around 130% (FIG. 37c), which is similar to the 2^{nd} batch sample. It should be noted that the water uptake may vary depending on the set environment.

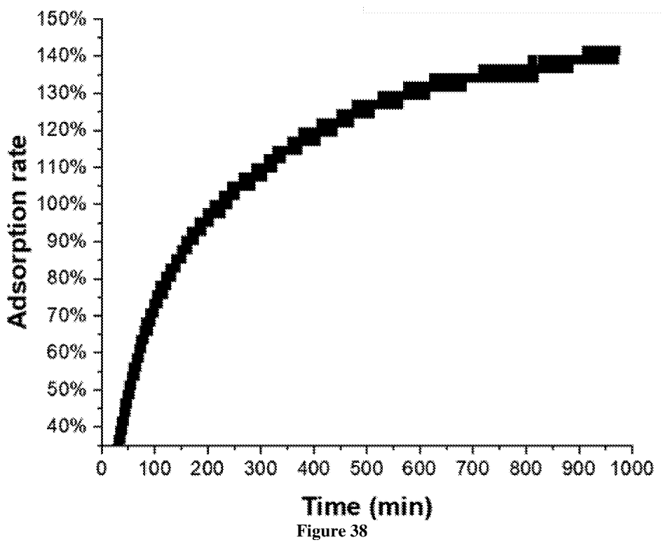

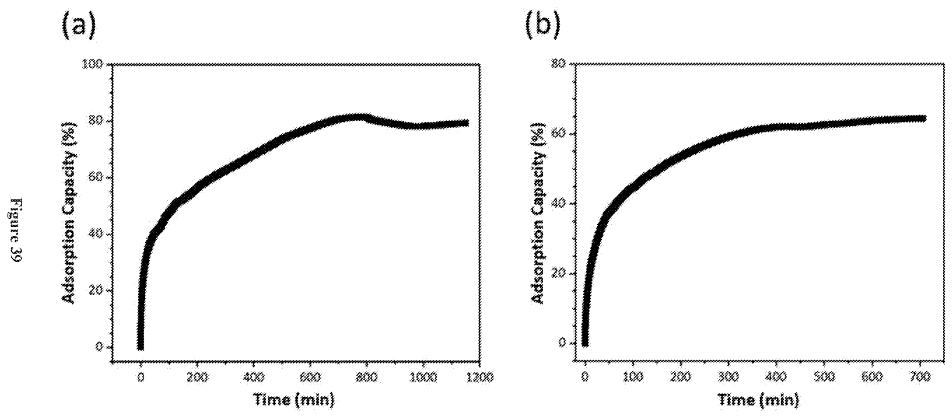

The performance on a large-scale was then compared with that on a smaller one. A small piece of aerogel (˜0.4 g) was taken from the 2^{nd} batch sample and was dried under nitrogen overnight before the test. The experimental condition was set the same at 85-95% humidity in a glove bag. Within 17 hrs, an adsorption rate of 140% was achieved, which is consistent with the result obtained for the large-scale 2^{nd} batch aerogel (FIG. 38).

### Adsorption Performance of GO-Aerogel at Different Concentration of GO Suspension

A range of experiments were performed using GO suspensions having 1 wt. % and 1.5 wt. % concentration. The aerogel samples were formed by crosslinking GO with calcium chloride (Ca²⁺) crosslinkers.

### GO-Suspension at 1 wt %

### Varying the Weight Ratio Between GO and Crosslinker

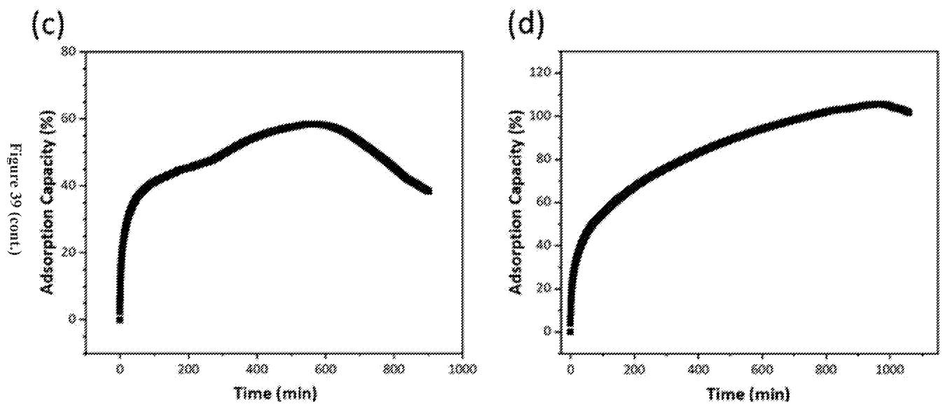

GO suspension with 1 wt % of concentration was used to prepare aerogels. Firstly, GO was crosslinked with Ca²⁺ at different weight ratios (GO:Ca²⁺): 100:1, 50:1, 10:1, 1:5 and 1:1, respectively. The experiment was performed at 95-100% relative humidity in a glove bag. It was found that the equal ratio of GO and crosslinker leads to the highest adsorption capacity up to ˜260%. FIG. 39 illustrates the adsorption performance of aerogels by varying the weight ratio of GO to metal ions. As shown in FIG. 39b, the capacity increases with increasing the content of metal ions to reach the same mass ratio as GO.

### Varying the Thickness of Aerogel by Compression

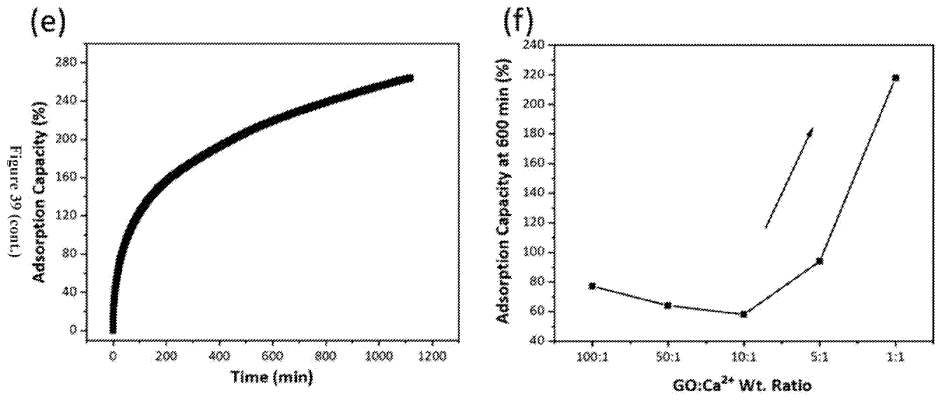

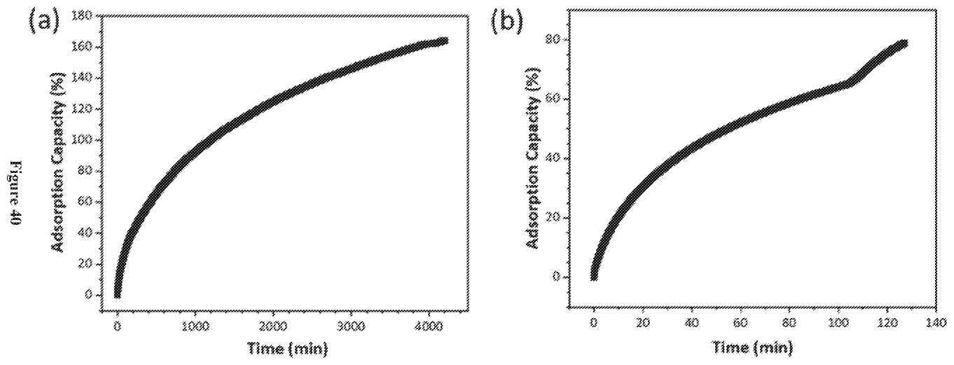

The adsorption tests of GO-aerogel with different thickness was also tested. GO in 1 wt. % was firstly crosslinked with Ca²⁺ in 1:1 wt ratio, followed by freeze-drying towards aerogel formation. The thickness of aerogel was then tuned by compression under different pressure: ˜0.07 bar, ˜1.5 bar, and ˜10 bar by using 3D printed canister as shown in FIG. 40d. The adsorption performance was then undertaken at 95-100% relative humidity. As shown in FIG. 40a-c, the adsorption performance of aerogel decreased from ˜165% to ˜79% and ˜29% when it was compressed under higher pressure.

### GO-Suspension at 1.5 wt %

### Role of Ultrasonication on the Performance of Aerogel

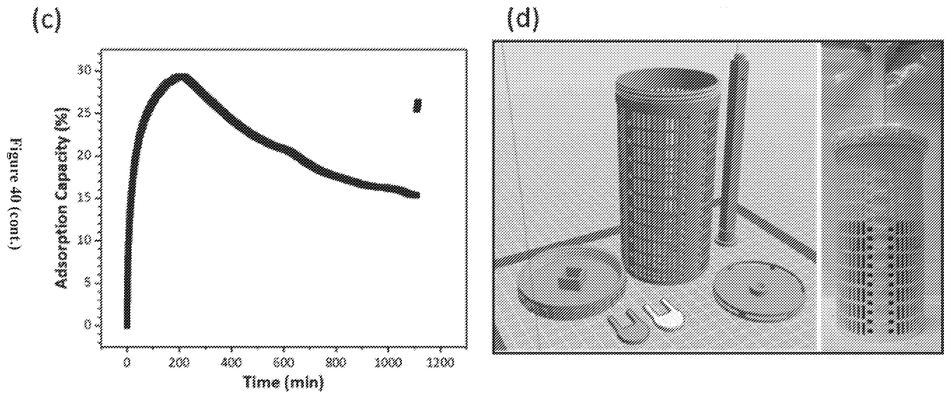

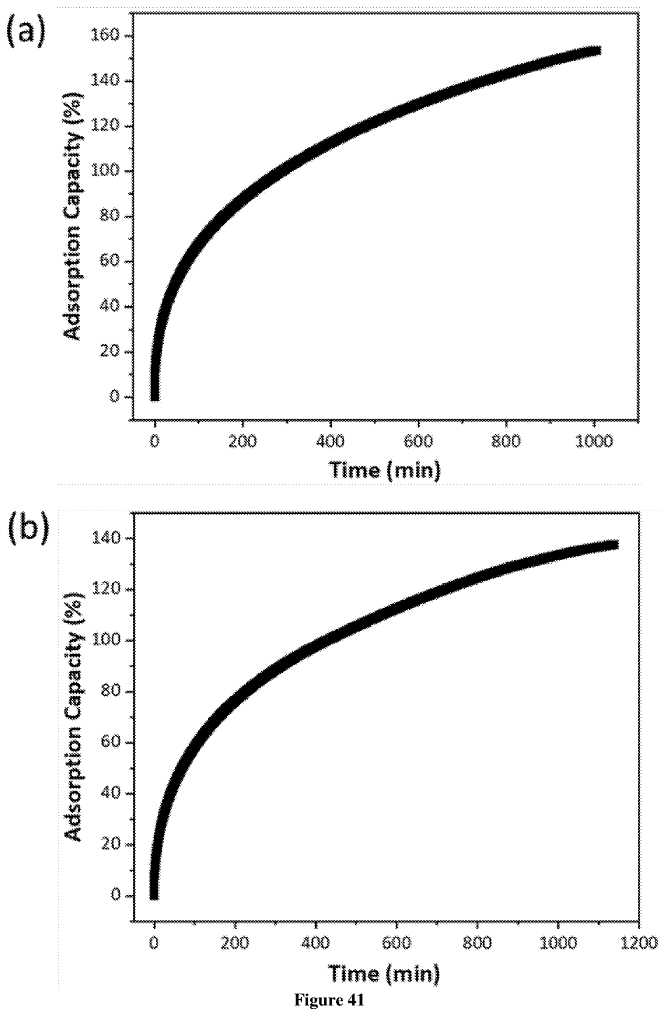

The effect of ultrasonication during sample preparation, i.e. while crosslinking GO with Ca²⁺, was investigated. Two aerogel samples were individually crosslinked with calcium chloride at the weight ratio of 2:1 (GO:Ca²⁺). One sample was then ultrasonicated for 10 min, then both suspensions were freeze-dried towards forming aerogels. As presented in FIG. 41, no significant difference was observed between aerogel samples prepared with and without ultrasonication. The experiment was performed in the glove bag with 95-100% relative humidity.

### Adsorption Performance at Different Humidity

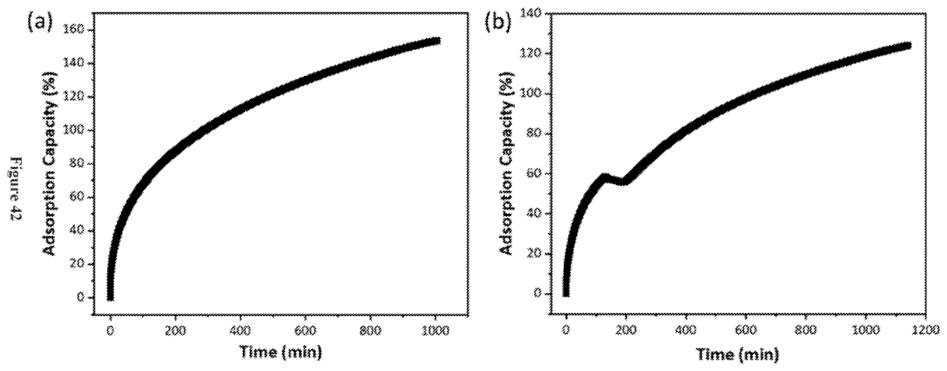

Aerogels were prepared by crosslinking GO (1.5 wt %) with Ca²⁺ metal ions at 2:1 weight ratio, and the adsorption performance of the aerogels was conducted at different humidity: 95-100%, 80%, 70%, and 50%, respectively. As depicted in FIG. 42, ˜154% water uptake was obtained at 100% humidity, this decreased to ˜56%, ˜40%, and 30% when the relative humidity was reduced to 80%, 70%, and 50% respectively.

### Isotherm Tests

A number of aerogel samples in cake form were tested for their isotherm adsorption-desorption behaviour.

### Desorption Under Different Conditions: Atmospheric Pressure and Vacuum

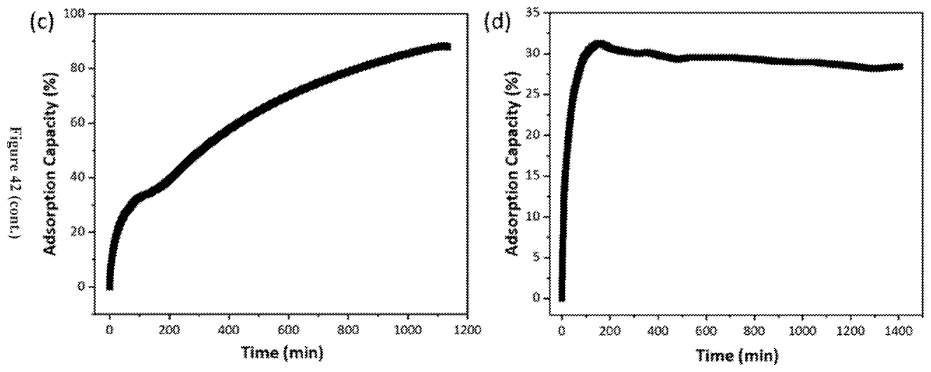

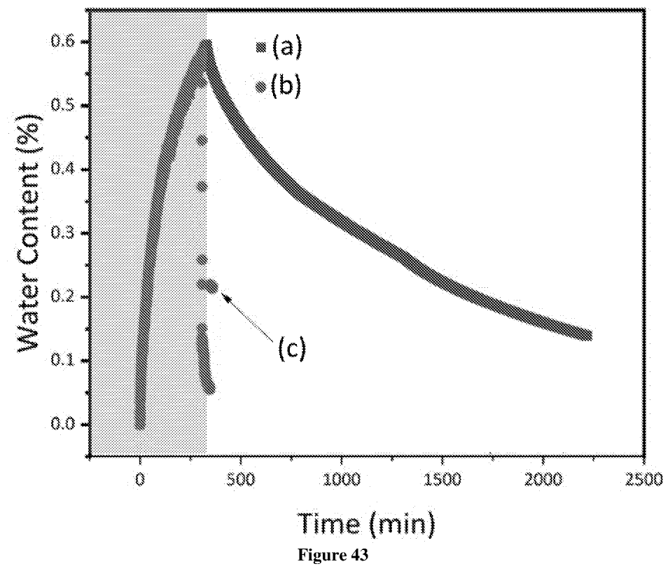

˜2.7 g of GO-aerogel was prepared by crosslinking with Ca²⁺ in a 1:1 weight ratio. An adsorption test was undertaken at 85% RH for 42 hrs, followed by desorption under two different conditions: atmospheric pressure and under vacuum. FIG. 43 shows the 1^{st} cycle of the adsorption-desorption process (desorption under atm), while the grey highlighted area shows the 2^{nd} cycle (desorption under vacuum). Although the adsorption was around 60% within the set time frame, the aerogel still exhibited good adsorption performance even in the 2^{nd} cycle of the process. In terms of desorption, gradual water release was observed under atmospheric pressure, while a significant enhancement was obtained under vacuum conditions.

### Adsorption at 85° C. and Desorption Under Dry Air at 30° C.

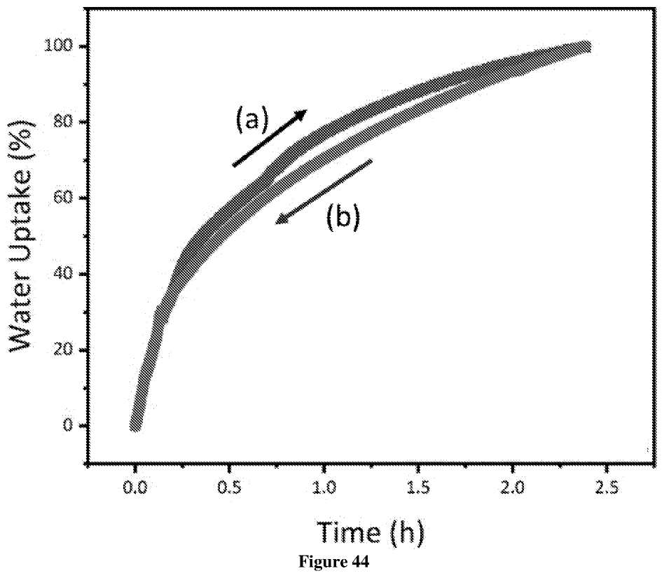

Another set of isotherm experiments was undertaken, in which the 2^{nd} batch of 40 g aerogel sample was used. ˜8.57 g of aerogel was thoroughly dried under nitrogen before the adsorption test at 85% humidity. As shown in FIG. 44, the water uptake of the aerogel reached 100% within 2.5 hr. Then the desorption test was performed under dry air at 30° C. The desorption spectrum presented in FIG. 44 shows complete water recovery from the aerogel under ambient conditions.

### Adsorption at 85° C. and Desorption Under Dry Air at 40° C.

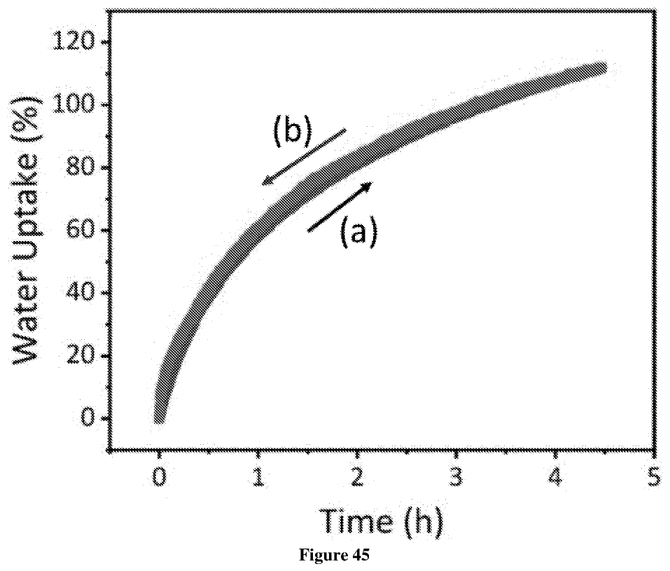

Desorption performance at another mild temperature (40° C.) was also investigated. The experimental condition for the adsorption test were as follows: ˜3.73 g of aerogel was incubated at the same humidity (85%), and then the desorption was performed under dry air at 40° C. According to the isotherm curve shown in FIG. 45, ˜110% of water uptake was achieved within 5 hrs, and successful desorption was also observed.

### Adsorption at 55% and Desorption Under Dry Air at 40° C.

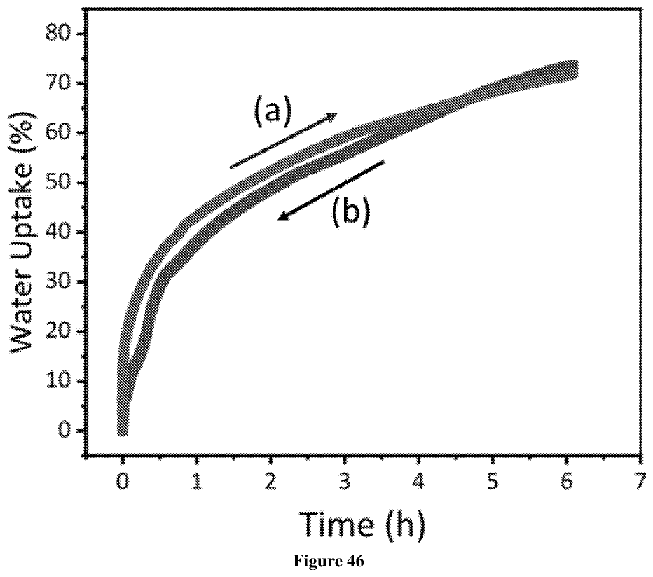

After investigating the efficiency of desorption of aerogel at low temperature, another isotherm was performed under mild conditions for both adsorption and desorption tests. In the experiment, ˜2.91 g of aerogel prepared by crosslinking with Ca²⁺ in 1:1 weight ratio was incubated at 55% humidity for 6 hrs, resulting in approximately 75% water uptake. The desorption test was then performed under dry air at 40° C. FIG. 46 illustrates the isotherm curve showing the desirable performance of the GO-aerogel under ambient conditions.

Although the aerogels described herein have exhibited adsorption of water, a person of skill in the art would understand that the aerogels may also be suitable for adsorbing other small molecules, such as organic solvents, e.g. methanol, ethanol etc., or gases, such as carbon dioxide, nitrogen, or sulfur dioxide.

Although the invention has been described with reference to specific examples, it will be appreciated by those skilled in the art that the invention may be embodied in many other forms. In particular, features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An aerogel comprising graphene oxide which is crosslinked with a metal ion, wherein the metal ion is selected from the group consisting of alkali metal ions, alkaline earth metal ions, transition metal ions and basic metal ions; and wherein said metal ion is not selected from the group consisting of Fe³⁺, Co²⁺, Ni²⁺, Cu²⁺, Zr⁴⁺, Sn⁴⁺, Ti⁴⁺, V⁵⁺, La³⁺, Cr³⁺, Al³⁺, Zn²⁺ and Ce⁴⁺.

2. The aerogel of claim 1, wherein:
the metal ion is selected from the group consisting of alkali metal ions and alkaline earth metal ions; or
the metal ion is an ion selected from the group consisting of: beryllium, magnesium, calcium, strontium, lithium and barium; or
the metal ion is selected from the group consisting of: Be²⁺, Mg²⁺, Ca²⁺, Sr²⁺, Li⁺, and Ba²⁺.

3. (canceled)

4. (canceled)

5. The aerogel of claim 1, wherein the metal ion is an alkaline earth metal ion.

6. The aerogel of claim 5, wherein the alkaline earth metal ion is Ca²⁺.

7. The aerogel of claim 1, wherein the metal ion is a basic metal ion or a transition metal ion.

8. The aerogel of claim 1, wherein:
the weight ratio of graphene oxide to metal ion is from about 200:1 to about 1:5; or the weight ratio of graphene oxide to metal ion is from about 5:1 to about 1:1; or
an average lateral dimension of the graphene oxide is about 500 nm or less; or
an average lateral dimension of the graphene oxide is about 500 nm or more; or
the carbon:oxygen ratio of the graphene oxide is from about 0.5 to about 5; or
the carbon:oxygen ratio of the graphene oxide is about 2.25; or
the adsorption capacity of the aerogel is from about 20 to about 400% at about 100% relative humidity; or
the density of the aerogel is from about 0.005 to about 0.25 g/cm³; or
the porosity of the aerogel is from about 90 to about 99.9%; or
the aerogel has an adsorption capacity of at least about 40% at about 100% relative humidity.

9. (canceled)

10. (canceled)

11. (canceled)

12. (canceled)

13. (canceled)

14. (canceled)

15. (canceled)

16. (canceled)

17. (canceled)

18. A method for preparing an aerogel, said aerogel comprising graphene oxide which is crosslinked with a metal ion, wherein the metal ion is selected from the group consisting of alkali metal ions, alkaline earth metal ions, transition metal ions and basic metal ions; and wherein said metal ion is not selected from the group consisting of Fe³⁺, Co²⁺, Ni²⁺, Cu²⁺, Zr⁴⁺, Sn⁴⁺, Ti⁴⁺, V⁵⁺, La³⁺, Cr³⁺, Al³⁺, Zn²⁺ and Ce⁴⁺, the method comprising the steps of:
(a) contacting graphene oxide with a crosslinking agent in the presence of a liquid; and
(b) removing the liquid to form the aerogel.

19. The method of claim 18, wherein removing the liquid is by freeze-drying.

20. The method of claim 19, wherein:
after the contacting step, the graphene oxide is transferred to a mould prior to the freeze-drying step; or
the freeze-drying step is conducted under conditions of −60° C. temperature, and over a period of 2 to 24 hours; or
the liquid comprises water.

21. (canceled)

22. (canceled)

23. The method of claim 18, wherein the method comprises the steps of: providing an aqueous solution of graphene oxide at a predetermined concentration, followed by exposure to a crosslinking agent thereby providing a cross-linked graphene oxide.

24. The method of claim 23, wherein the crosslinking agent is added to the aqueous solution of graphene over a period of 10 minutes to 6 hours; or wherein the concentration of graphene oxide in the aqueous solution is from about 0.01 to about 20 wt. %, from about 0.05 to about 5 wt. % or about 1 wt. %.

25. (canceled)

26. (canceled)

27. (canceled)

28. The method of claim 18, wherein the crosslinking agent includes the metal ion.

29. The method of claim 18, wherein the metal ion is selected from the group consisting of alkali metal ions and alkaline earth metal ions.

30. The method of claim 29, wherein the alkaline earth metal ion and/or alkali metal ion is selected from the group consisting of: beryllium, magnesium, calcium, strontium, lithium and barium.

31. The method of claim 18, wherein the crosslinking agent is selected from the group consisting of: CaCl₂) and MgCl₂.

32. The method of claim 18, wherein the metal ion is a basic metal ion or a transition metal ion.

33. The method of claim 18, wherein after the removing step, the aerogel is compressed.

34. The method of claim 33, wherein the aerogel is compressed to about 50% of its original volume.

35. (canceled)

36. (canceled)

37. (canceled)

38. (canceled)

39. (canceled)

40. An atmospheric water generator comprising a graphene oxide aerogel.

41. The atmospheric water generator of claim 40, wherein the graphene oxide aerogel comprises graphene oxide which is crosslinked with a metal ion, wherein the metal ion is selected from the group consisting of alkali metal ions, alkaline earth metal ions, transition metal ions and basic metal ions; and wherein said metal ion is not selected from the group consisting of Fe³⁺, Co²⁺, Ni²⁺, Cu²⁺, Zr⁴⁺, Sn⁴⁺, Ti⁴⁺, V⁵⁺, La³⁺, Cr³⁺, Al³⁺, Zn²⁺ and Ce⁴⁺.
